(19) United States
(12) Patent Application Publication
(10) Pub. No.: US 2012/0267549 A1
(43) Pub. Date: Oct. 25, 2012

(54) METHODS AND APPARATUS FOR FLUORESCENCE SENSING EMPLOYING FRESNEL ZONE PLATES

(75) Inventors: Kenneth B. Crozier, Cambridge, MA (US); David A. Weitz, Bolton, MA (US); Ethan Schonbrun, Newton Highlands, MA (US); Adam R. Abate, San Francisco, CA (US)

(73) Assignee: President and Fellows of Havard College, Cambridge, MA (US)

(21) Appl. No.: 13/319,129

(22) PCT Filed: May 7, 2010
(86) PCT No.: PCT/US10/01372

§ 371 Date: Jul. 11, 2012

Related U.S. Application Data
(60) Provisional application No. 61/176,361, filed on May 7, 2009.

(51) Int. Cl. G01N 21/03; G01N 21/64

(52) U.S. Cl. 250/432 R; 250/428; 250/208.1; 250/200

(57) ABSTRACT

Methods and apparatus for high-throughput fluorescence detection using integrated microfabricated optical element arrays are described. In one example, the optical element arrays may comprise one or more microfabricated Fresnel zone plates, which may be configured to collect light from samples flowing in microfluidic channels. Multiple samples may be inspected in parallel at significantly high rates (e.g., about 200,000 samples per second or higher). A relay lens combined with high numerical aperture integrated microfabricated optical elements provides significant signal enhancement (e.g., on the order of at least 200 times that of conventional fluorescence detection methods).

### CROSS-REFERENCE TO RELATED U.S. APPLICATIONS

The present application claims priority to U.S. provisional patent application No. 61/176,361 filed on May 7, 2009, which is incorporated herein by reference.

### STATEMENT REGARDING GOVERNMENT FUNDING

This invention was made with government support under PHY-0646094, DBI-0649865, and DMR-0820484 awarded by the National Science Foundation and under HR0011-06-1-0044 awarded by the U.S. Department of Defense. The government has certain rights in the invention.

### BACKGROUND

Fluorescent microscopy and fluorescent labeling have become powerful measurement and diagnostic techniques in the biological sciences. Genes, cells, molecules, small molecules, peptides, viruses, and oligonucleotides can be labeled with fluorescent tags tailored to provide diagnostic information about characteristics of the labeled species when the species is subjected to varied biological conditions. In laboratory studies, fluorescent emission is typically monitored from the labeled species to determine the effect of the varying biological conditions, e.g., the effect of a pharmaceutical agent applied to the species. Conventional fluorescence detection utilizes large microscopes adapted for fluorescent imaging applications or refractive optical imaging or detection systems also adapted for fluorescence detection. Conventional fluorescence detection apparatuses are typically large pieces of equipment, which are complex in design and require high-quality (expensive) optical components.

### SUMMARY

The inventors have appreciated that conventional fluorescence detection apparatuses are not suited for, or readily adapted for, high-throughput, parallel fluorescence detection, in which a plurality of fluorescing objects may be inspected simultaneously. To this end, the inventors have recognized and appreciated that microfabricated optical elements can be designed and integrated with microstructures (for holding/carrying samples/objects for inspection) in a system adapted for high-throughput, parallel fluorescence detection.

In view of the foregoing, the present disclosure is directed generally to inventive methods and apparatus for fluorescence sensing using one or more microfabricated optical elements. In various embodiments, the microfabricated optical elements may be diffractive optical elements; for example, in one implementation the optical elements may be Fresnel zone plates.

In some embodiments, a single microfabricated optical element (e.g., a single zone plate) or an array of optical elements may be used with a single low-numerical-aperture relay optic in a high-throughput fluorescence detection system. Also, in some embodiments one or more optical elements may be integrated with a microfluidic structure having an array of microfluidic channels. The microfluidic channels can be configured to support a stream of fluid that includes fluorescently labeled objects (e.g., microparticles and/or biological species), which objects are conveyed in the stream to respective optical elements in the array of optical elements. In one exemplary implementation, the stream of objects may be provided from a droplet generator that provides fluorescently-labeled droplets dispersed in the microfluidic stream. The inventors have appreciated that exemplary microfabricated, integrated optical element array/microfluidic apparatus (also referred to as “micro-optofluidic” apparatus) are useful in high-throughput drug screening applications.

According to one aspect of the technology described herein, an apparatus for detecting fluorescence from small objects comprises at least one microfluidic channel, at least one microfabricated optical element coupled to the at least one microfluidic channel, and a relay optic. The optical element may be disposed with respect to the microfluidic channel so that an optical axis of the microfabricated optical element passes through the microfluidic channel. The relay optic may be configured to operate as a confocal pinhole aperture and relay at least a portion of radiation from the at least one microfabricated optical element to a location, e.g., to a location at which a detector is mounted. The microfabricated optical element may be a microlens or a microfabricated Fresnel zone plate.

According to another aspect, a multilayer apparatus for detecting fluorescence comprises a first layer comprising a first substrate, and a second layer comprising a second substrate. In various embodiments, the second layer is in releasable contact with the first layer. At least one Fresnel zone plate may be disposed on the first substrate, and at least one microfluidic channel may be disposed on the second substrate. In various implementations, the Fresnel zone plate is configured to have a first focal region for excitation radiation, the first focal region substantially outside the microfluidic channel, and a second focal region for fluorescent emission excited by the excitation radiation, the second focal region substantially within the microfluidic channel.

In yet an additional aspect of the technology, an apparatus for detecting fluorescence from small objects comprises an array of microfabricated optical elements, and a microfluidic drop generator configured to generate microfluidic drops, wherein the array of optical elements and the microfluidic drop generator are integrated on a same chip. The array of optical elements may be an array of microfabricated Fresnel zone plates. A single relay optic may be configured to relay at least a portion of fluorescent emission collected by any one of the optical elements in the array to an imaging detector. High-throughput fluorescence detection at rates of nearly 200,000 samples per second can be achieved with an integrated optical element array, a single relay optic, and a high-speed imaging detector.

A further aspect of the technology is directed to a fluorescence sensing method that comprises steps of irradiating at least one microfabricated diffractive element with excitation radiation, the at least one microfabricated diffractive element being configured to focus the excitation radiation onto at least one microfluidic channel. The sensing method further comprises providing a flow of at least one object in the microfluidic channel. In various embodiments, the object generates a fluorescent emission when irradiated by the excitation radiation, and at least a portion of the fluorescent emission passes through the microfabricated diffractive element. The method may further comprise relaying at least some of the portion of the fluorescent emission passing through the microfabricated diffractive element to a location with a relay optic. The relay optic may be configured to exclude radiation emitted a selected distance from the object that generates the fluorescent emission. For example, the relay optic may be configured to operate as a confocal aperture and exclude fluorescent emission and other radiation originating from locations outside of a focal region, the focal region associated with the microfabricated diffractive element.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

The foregoing and other aspects, embodiments, and features of the present teachings can be more fully understood from the following description in conjunction with the accompanying drawings.

### BRIEF DESCRIPTION OF THE DRAWINGS

The skilled artisan will understand that the figures, described herein, are for illustration purposes only. It is to be understood that in some instances various aspects of the invention may be shown exaggerated or enlarged to facilitate an understanding of the invention. In the drawings, like reference characters generally refer to like features, functionally similar and/or structurally similar elements throughout the various figures. The drawings are not necessarily to scale, emphasis instead being placed upon illustrating the principles of the teachings. The drawings are not intended to limit the scope of the present teachings in any way.

FIG. 1A depicts an exemplary zone-plate-based optical microscopy system containing a microfabricated optical element 120 and relay optic 140 according to one embodiment of the present invention.

FIGS. 1B-1C illustrate illumination of an object 103 to be optically inspected according to various embodiments of the present invention.

FIG. 2A is a depiction of a Fresnel zone plate pattern, which may be integrated with a microfluidic structure according to the present disclosure.

FIG. 2B is a micrograph (greatly magnified image) of an embodiment of a microfabricated Fresnel zone plate. The scale bar indicates the size of the zone plate, (about 100 microns in diameter) and the inset shows portions of the outer rings of the zone plate.

FIG. 2C is an atomic force microscope (AFM) trace across the center of a zone plate and represents the zone plate's topography for the selected embodiment.

FIG. 2D illustrates an embodiment of dual focusing with a microfabricated Fresnel zone plate. Two focal regions are provided, a first focal region 252 for excitation radiation and a second focal region 251 for fluorescent emission.

FIGS. 3A-3C depict various embodiments of microfabricated optical elements.

FIGS. 3D-3F depict various embodiments of multilayer, integrated micro-optofluidic structures.

FIG. 4 illustrates an embodiment of a zone-plate microscopy system having a plurality of zone plates and a single relay optic, which may be used for parallel inspection of plural objects 103.

FIG. 5 is a plan view of an array of zone plates integrated with a droplet generator according to one embodiment of the technology.

FIG. 6A is a plan view of an array of zone plates integrated with a single serpentine microfluidic channel according to one embodiment of the technology.

FIG. 6B is a plan view of an array of zone plates integrated with an array of microfluidic channels according to one embodiment of the technology.

FIG. 7 represents a method flow diagram according to one embodiment of the micro-optofluidic technology.

FIG. 8A shows signals recorded from three zone plates of an array for an embodiment like that depicted in FIG. 6A. Five microscale fluorescent objects were conveyed along the microfluidic channel giving rise to the five sets of signals.

FIGS. 8B-8C are results obtained by processing the data of FIG. 8A. These results give information about flow dynamics within the microfluidic channel.

FIG. 9A is a graph of measured relative fluorescence intensity as a function of position, and shows an enhancement in emission due to focusing of excitation radiation by a single microfabricated zone plate.

FIG. 9B is a graph showing enhancement of fluorescence collection due to a single microfabricated zone plate.

FIG. 10A-10B show measured fluorescence signal changes as microscale droplets flow past two zone plates in a zone plate/microfluidic chip similar to the embodiment depicted in FIG. 6B. The chip comprised 64 microfabricated zone plates integrated with 64 channels. The data shows that about 190,000 fluorsecing droplets per second can be detected with the inventive apparatus.

The features and advantages of the present invention will become more apparent from the detailed description set forth below when taken in conjunction with the drawings.

### DETAILED DESCRIPTION

### Introduction

The inventors have appreciated that fluorescence detection is amongst the primary methods for conventional analysis of microscale objects disposed in microfluidic devices. At the same time, the inventors have recognized several drawbacks associated with conventional techniques for detecting fluorescence from microscale objects. In most microfluidic assays, fluorescence is observed using, for example, a conventional fluorescence microscope that suffers from a limited field of view and is difficult to parallelize. In order to achieve a high fluorescence signal collection efficiency, significantly large-valued numerical aperture (NA) microscope objective lenses often are used, which in turn limits the field of view (e.g., a conventional 40× microscope objective having a numerical aperture of 0.65 has a field of view less than 500 microns). The fluorescence detection region within the field of view is therefore usually confined to a single location along a channel, which limits the measurement of any dynamic process. To increase the field of view, signal collection efficiency (and signal quality) is sacrificed. Because the conventional microscope is large (and expensive), parallelization can be impractical.

Optical detection in biological or biochemical assays is typically performed conventionally by quantification of a fluorescence signal in a discrete volume or container. With respect to small sample volumes, recent research in microfluidics systems, and in particular two phase microfluidic technology, has demonstrated the ability to produce picoliter sized containers of fluid, called drops, at rates of several kilohertz per device. (See G. M. Whitesides, Nature, 2006, 442, 368-373; and S. L. Anna, N. Bontoux, and H. A. Stone, Applied Physics Letters, 2003, 82, 364:366). Based on the foregoing, the inventors have recognized and appreciated that droplet-based microfluidics is well-suited for carrying out high-throughput screening (and other applications that require a large number of reactions to be executed) in small volume samples.

The inventors also have appreciated that microfluidic devices can be parallelized on a single chip using lithographic techniques, further increasing the rate at which samples can be produced and manipulated. However, as the size of parallelized devices scale up, conventional optical detection becomes increasingly difficult, because of the tradeoff between field of view and collection efficiency for conventional fluorescence detection systems, e.g., conventional fluorescence microscopes.

To overcome these challenges, however, the inventors have recognized that optical imaging systems requiring a wide field of view and a small form factor can benefit from the use of a lens array. (See A. W. Lohmann, Applied Optics, 1989, 28, 4996-4998; R. Volkel, M. Eisner, and K. J. Weible, Microelectronic Engineering, 2003, 67-68, 461-472; and L. P. Lee and R. Szema, Science, 310, 2005, 1148-1150.)

In view of the foregoing, the inventors have developed fluorescence sensing apparatus and methods based on the integration of microfabricated optical lens elements (e.g., small diffractive elements, such as Fresnel zone plates), examples of which can be used readily in conjunction with (i.e., integrated with) massively parallel microfluidic devices in high-throughput sensing applications. Accordingly, various embodiments of the present invention are directed to using arrays of high numerical aperture (NA) microfabricated lenses, e.g., Fresnel zone plates, for both fluorescence excitation and collection associated with fluorescence detection of microscale objects. Both the microfluidics and the lens array may be integrated into a multilayer chip in various implementations, as discussed in detail below.

Embodiments of the lens array and detection apparatus according to the present invention facilitate simultaneous detection from a plurality of regions on a microfluidic chip, which may be separated by several times the field of view of traditional high-NA objective lenses used in conventional microscopes. The inventors have recognized that multiple detection at large sample spacing also makes possible temporal resolution of dynamic processes such as mixing or reaction kinetics.

In overview, methods and apparatus for high-throughput fluorescence detection using microfabricated optical element arrays integrated with microfluidic channels are described. Exemplary embodiments of the microfabricated optical element arrays may comprise one or more microfabricated Fresnel zone plates, which may be configured to collect light from microscale objects flowing in the microfluidic channels. In one exemplary implementation, multiple samples may be inspected in parallel at rates of about 200,000 samples per second for a single array having 64 lenses.

A microfluidic chip and fluorescence detection apparatus, according to some embodiments of the present invention, may be implemented as an integrated structure constituting a “chip.” In various aspects, such a chip may comprise a two or three layer structure within (or on) which is integrated a high-NA microfabricated optical element or microfabricated optical element array. Additional detection optics may comprise a single relay optic, a bandpass filter, and a photodetector or an imaging detector, according to certain embodiments. In exemplary implementations, the single relay optic combined with high numerical aperture integrated optical elements can provide signal enhancement on the order of 200 times or greater compared to that provided by conventional fluorescence detection methods.

As noted above, the optical elements of the array (also referred to herein as a “lens array”) may comprise microfabricated lenses such as Fresnel zone plates, or any other suitable optical elements, one or more of which may have a large numerical aperture, e.g., greater than about 0.5. The optical elements may be integrated onto a microfluidic chip and configured to provide high light collection efficiency, e.g., in some embodiments comparable to the collection efficiency of high performance objective lenses of conventional microscopes. The integration of a plurality of microfabricated lenses onto a microfluidic chip facilitates observation of a large number of sample areas with high light collection efficiency for each area. The lens array may be used to perform measurements in parallel, for example by using each of the microfabricated optical elements of the array to collect light (e.g., fluorescent emission from a respective microscale sample) for a separate measurement. Thus, large amounts of data may be collected simultaneously.

Further details of the apparatus and methods for fluorescence sensing according to various embodiments of the present invention are described in the following sections.

Apparatus

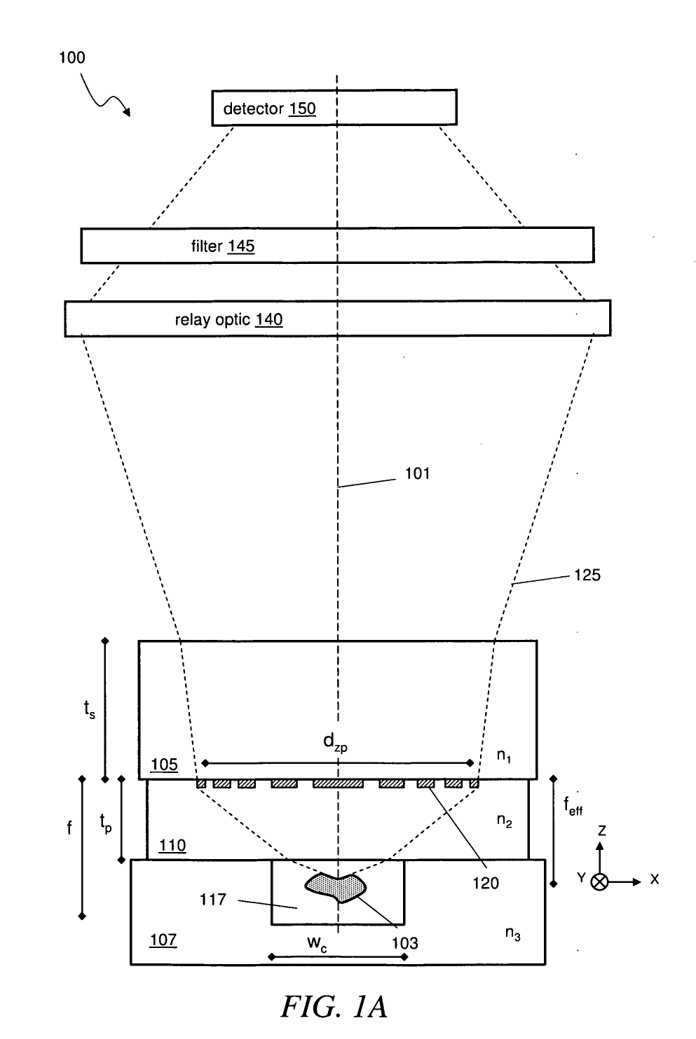

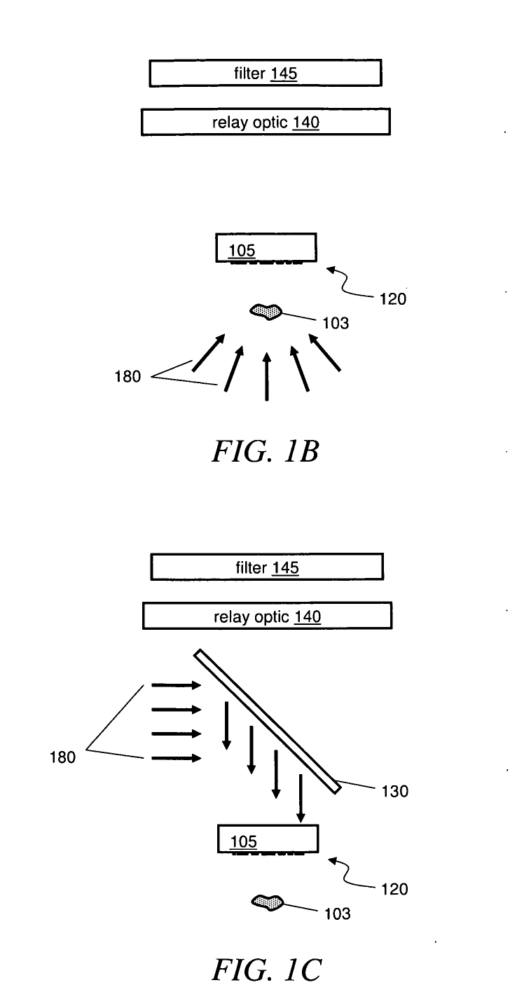

Referring to FIG. 1A in overview, a sensing apparatus 100 according to one embodiment of the present invention comprises at least one microfabricated optical element 120 (e.g., a Fresnel zone plate) integrated onto a chip having at least one microfluidic channel 117. The apparatus may further comprise a relay optic 140, configured to relay fluorescent emission from a microscale object 103 to a location, e.g., a location at which a detector 150 is positioned. The drawing of FIG. 1A represents an elevation view of the apparatus and shows the optical element 120 in cross section. The microfabricated optical element 120 may be disposed on a substrate 105, and may, in some implementations, be covered with a layer of material 110 (examples of which are discussed further below). The apparatus 100 may further comprise an optical filter 145 and detector 150. The drawing depicts marginal optical rays 125 that represent outer most fluorescent rays originating from the object 103 and collected by the zone plate/relay optic combination. An object 103 to be inspected, e.g., a fluorescing microscale object, may be positioned in a focal region of the microfabricated optical element 120. In exemplary implementations, the relay optic 140, optical element 120, and object 103 generally are aligned substantially along an optical axis 101.

For purposes of the following descriptions, the microfabricated optical element located near the object 103 providing an optical focusing characteristic is identified as a Fresnel zone plate 120 (i.e., a microfabricated diffractive lens). However, it should be appreciated that the optical element may be any suitable microfabricated diffractive optical element. For example, in other implementations contemplated by the present invention, the optical element may alternatively comprise a refractive microlens or may comprise a combination of a refractive and diffractive microfabricated optical element (e.g., a microfabricated binary optical element that may be produced by gray-scale dose exposure of a polymeric resist, by micromolding, or by imprint lithography). In various aspects, the microfabricated optical element provides at least one focusing characteristic and comprises a microfabricated optical lens. The optical element may provide additional focusing characteristics (e.g., multiple focal spots), as described in international patent application PCT/US2008/011033 to common inventors, filed Sep. 23, 2008, and now published under publication number WO2009/088399 (which publication is hereby incorporated by reference herein in its entirety).

In FIG. 1A, the zone plate 120 may be a microfabricated zone plate having a diameter d_{zp} less than one millimeter. In certain embodiments the diameter of the zone plate is between about 10 microns and about 500 microns, or more concisely between 10 microns and 500 microns. As noted elsewhere, the drawing of FIG. 1A is not to scale, and the zone plate is typically much smaller than the relay optic and located a relatively large distance, as compared with the zone plate diameter, from the relay optic 140. As one non-limiting example, the zone plate 120 may measure about 100 microns in diameter, d_{zp}, and the relay optic 140 may be located a distance between about 10 mm and about 200 mm, more particularly between 10 mm and 200 mm, from the zone plate.

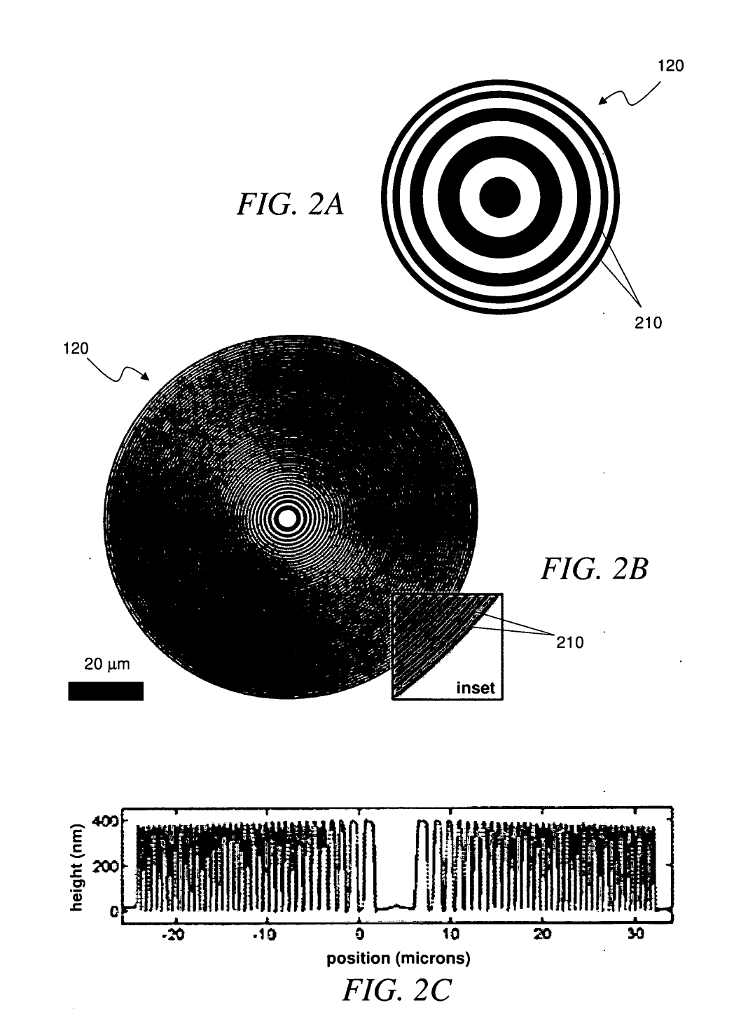

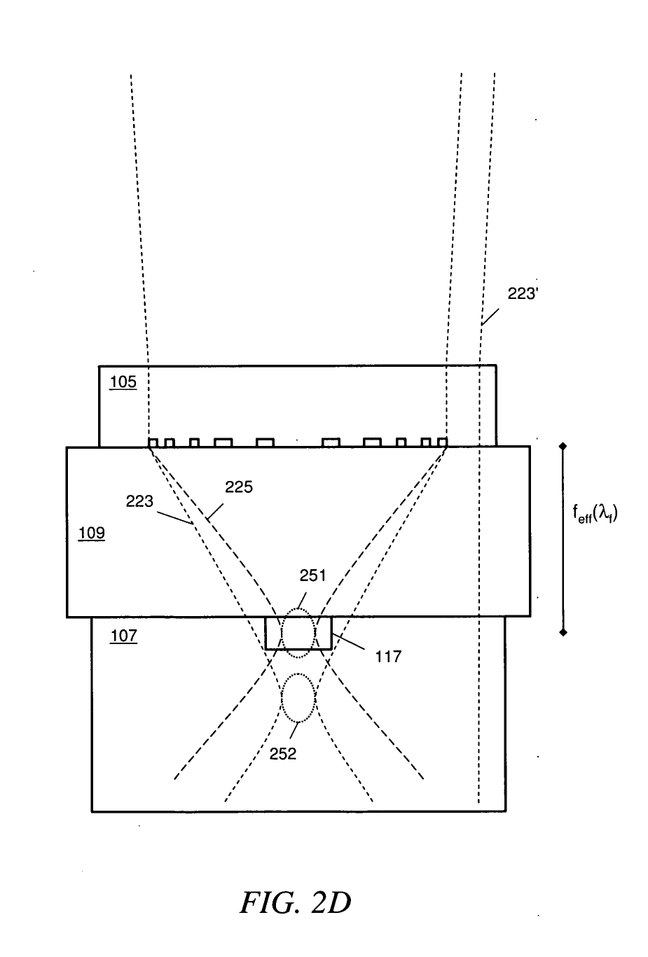

An embodiment of a Fresnel zone plate 120 is comprised of concentric rings 210 of varying width, as depicted in the plan views of FIGS. 2A-2B. FIG. 2A is a rendering depicting a generalized pattern of a zone plate, and FIG. 2B is a micrograph of microfabricated Fresnel zone plate 120. The scale marker shows that the zone plate has a diameter d_{zp} of about 95 microns, about the width of human hair. The inset in FIG. 2B shows the fine outer rings of the zone plate, which measure less than one micron in width. By way of description and without being bound to any particular theory, the radii of the zone plate rings 210 may be given by the following relation

rₘ=\sqrt{mλf+m²λ²/4} EQ. 1

where m is an integer, f is the focal length for the optical wavelength λ as measured in the medium in which the zone plate focuses radiation. If the zone plate is immersed in a medium having a refractive index n, then λ takes on the effective value of the wavelength in the medium λ/n.

A cross-sectional view of a zone plate, according to one embodiment of the present invention, is shown in the atomic force microscopy trace of FIG. 2C, and shows the topography of the zone plate's rings. The trace shows that the rings are about 400 microns tall. These rings were patterned in SU-8 photoresist.

The rings 210 of the zone plate provide the diffractive and optical focusing characteristic of the zone plate. The focusing characteristic of the zone plate 120 may be characterized, or parameterized, by a focal length f. Generally, the focal length f may be regarded as the “free space” focal length for the zone plate. For example, when collimated light impinges on and passes through the zone plate into air, it will come to a focus on an optical axis of the zone plate at a distance f from the zone plate. In FIG. 1A the optical axis of the zone plate is substantially collinear with the optical axis 101. Conversely, when a point source of radiation is located at the focus of the zone plate, emitted radiation collected by and passing through the zone plate will be substantially collimated. The zone plate then acts as an optical lens, even though it is a substantially planar device.

The focal length f of the zone plate 120 may be determined by the pattern of the rings 210. In general, ring patterns that have a larger radial periodicity provide a longer focal length, and ring patterns of shorter periodicity yield shorter focal lengths. Thus, one can design the pattern of the zone plate to provide virtually any desired focal length. The zone plate diameter d_{zp} and focal length are related to the numerical aperture (NA) of the zone plate in free space according to the relation:

NA=sin[tan⁻¹(d_{zp}/2f)]. EQ. 2

A zone plate may also be characterized by its NA value. Generally, a larger NA value denotes a shorter focal length.

The inventors have recognized that employing zone plates 120 with significantly short focal lengths, or large NA values, can eliminate the need for a pinhole aperture in zone-plate-based confocal microscopy apparatus, similar to the apparatus as illustrated in FIG. 1A. This recognition is developed more fully in a co-pending application to the same inventors entitled, “Methods and Apparatus for Scanning Microscopy Using One or More Fresnel Zone Plates” and filed concurrently herewith (which application is hereby incorporated by reference herein in its entirety). In exemplary implementations of fluorescence detection, the numerical aperture of the zone plate 120 may be between about 0.5 and about 3.0, or more particularly between 0.5 and 3.0. The focal length of the zone plate 120 may be between about 0.5 micron and about 300 microns, more particularly between 0.5 micron and 300 microns. It will be appreciated that a zone plate having a significantly large NA may operate as an objective lens in the apparatus 100 of FIG. 1A; however, the cost of the zone plate can be significantly lower since it can be microfabricated in vast quantities. Additionally as noted above, the zone plate can be readily altered to provide virtually any value of focal length, or NA, for a particular application.

There is a subtlety in the operation of a zone plate when a material 110 and/or substrate 107 adjacent the zone plate 120 has an index of refraction n₂ and/or n₃ which differs from the index of refraction for air. In FIG. 1A the focal region is shown to be located a distance less than f from the zone plate 120. This can occur when the light passes through a material 110 having an index of refraction n₂ greater than 1, the index of refraction for air. A material 110 having a index of refraction greater than 1 disposed on the zone plate 120 may effectively shorten the focal length of the zone plate. In such a configuration, the NA of the zone plate is also changed; EQ. 2 is changed by multiplying the right side by the value of the index of refraction for the material (n₂ for the embodiment shown in FIG. 1A).

In various embodiments, the zone plate 120 is disposed on a substrate 105, which may have a thickness tₛ. The substrate will transmit at least a portion of the radiation that is emitted from the object 103 and that passes through the zone plate 120. The substrate may have an index of refraction n₁ that differs in value from 1.0. In exemplary embodiments, the thickness of the substrate 105 may be between about 5 microns and about 20 mm, or more particularly between 5 microns and 20 mm. In an alternative embodiment to FIG. 1A, the zone plate 120 may be located on an upper surface of the substrate 105, and the material 110 may, or may not, be omitted. In some embodiments, the thickness of the substrate 105 may be on the order of a selected focal length of the zone plate 120. For example, the thickness of substrate 105 may be between about 0.5 and about 1.5 times the selected focal length of the zone plate. In some embodiments, the substrate is adapted to exhibit optical filtering characteristics such that it blocks a portion of radiation incident on the substrate 105.

According to some embodiments of the present invention, a Fresnel zone plate 120 is designed to provide two focal lengths, a first focal length associated excitation or illumination radiation, and a second focal length associated with fluorescent emission from the object 103. An example of a dual-focus zone plate configuration is shown in FIG. 2D. Since the Fresnel zone plate is a diffractive optical element, shorter wavelengths will be diffracted less than longer wavelengths. Accordingly, the zone plate can focus longer wavelengths at a shorter distance than shorter wavelengths. The inventors have appreciated this aspect and have designed an optical configuration to use this aspect advantageously, as illustrated in FIG. 2D. In exemplary implementations, the zone plate/microfluidic structure is configured such that a first focal region 252 for shorter-wavelength excitation radiation 223 falls substantially outside the microfluidic channel 117, and such that a second focal region 251 for the longer-wavelength fluorescence emission 225 lies substantially within the microfluidic channel 117. As can be appreciated from the drawing in FIG. 2D, the excitation radiation 223 overfills the microfluidic channel 117, which can advantageously assure that a microscale object travelling along the channel at any transverse location in the channel will be excited.

Excitation radiation 223′ that is not incident on the microfabricated optical element, such as zone plate 120, is not focused as can be seen in FIG. 2D. Excitation radiation 223′ can excite fluorescence in objects located away from the zone plate. However, since radiation 223′ is not focused, the amount of fluorescence it excites is significantly less. Additionally, this fluorescence is outside the field of view defined by the zone plate/relay optic combination. In various implementations, the microfabricated optical element enhances the excitation of fluorescence in an object by concentrating the excitation radiation, and enhances detection of fluorescence from the enhanced excitation region (shown below the zone plate in FIG. 2D.) Aspects of excitation and detection enhancement are described further in Example 3 below.

An object 103 to be inspected or imaged may be illuminated in any suitable manner. For one embodiment, the object may be illuminated by illumination or excitation radiation 180 generally from a side opposite the zone plate 120, as illustrated in FIG. 1B. In another embodiment, the object 103 may be illuminated generally from a same side on which the zone plate is located, as illustrated in FIG. 1C. For the embodiment shown in FIG. 1C, the zone plate may focus the illumination or excitation radiation 180 onto the object 103. A beamsplitter, dichroic mirror, or polarizing beamsplitter 130 may be used to direct at least a portion of the illumination radiation 180 towards the object 103 and to pass at least a portion of radiation emitted (not shown) from the object to the relay optic 140 and/or detector 150 (not shown). The beamsplitter 130 may be located as shown in FIG. 1C, or alternatively may be located at any position between the relay optic 140 and detector 150.

The zone plate 120, or arrays of zone plates, may be patterned and fabricated using any of a variety of microfabrication techniques. Patterning techniques include, but are not limited to, electron beam lithography, ion beam lithography, contact photolithography, optical projection lithography, x-ray lithography, zone-plate array lithography, imprint lithography, interference lithography, micromolding lithography, and soft lithography. Fabrication techniques include, but are not limited to, lift-off techniques, reactive ion etching, wet chemical etching, material deposition, chemical-mechanical polishing. Any combination of these techniques may be used to fabricate a zone plate 120, a linear array of zone plates, or a two-dimensional array of zone plates.

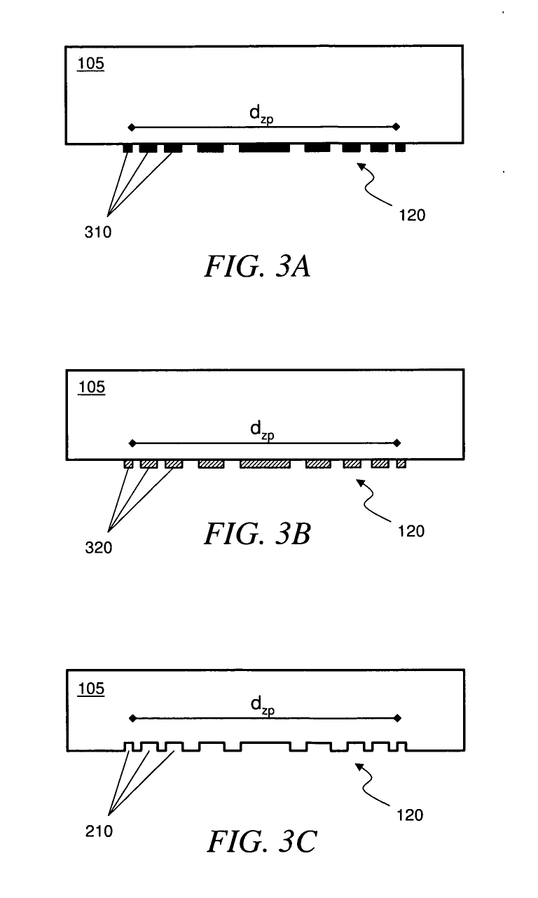

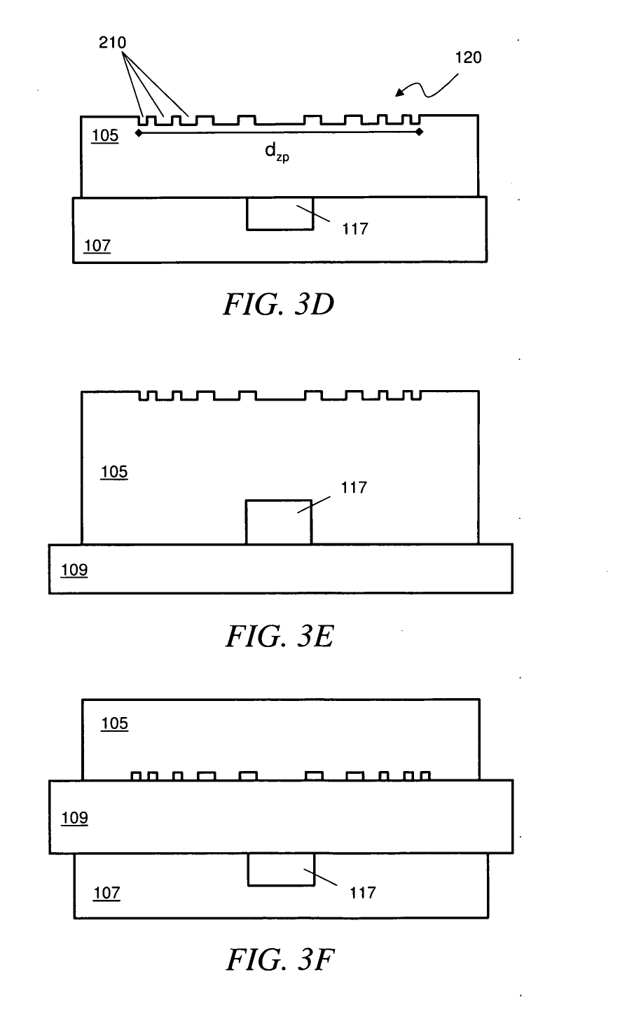

FIGS. 3A-3B depict embodiments of zone plates 120 that may be fabricated by various microfabrication techniques. As an example, FIG. 3A depicts an embodiment in which a zone plate has been patterned in metal 310 on a substrate. For this embodiment, a layer of electron-beam resist (not shown) disposed on the substrate 105 may first be patterned by electron beam lithography. A metal may then be evaporated onto the resist/substrate structure. Subsequent dissolution of the resist in a lift-off process will lift-off the metal except where the metal was evaporated onto the underlying exposed substrate. Although electron beam lithography is described for this embodiment, alternative forms of lithography may be used, (e.g., ion beam lithography, photolithography, contact printing, imprint lithography). It will be appreciated that various types of lithographic processes may be used to patter the zone plates in this and the following described embodiments.

FIG. 3B depicts an embodiment in which the zone plate has been patterned in an amorphous silicon material 320. In this embodiment, the amorphous silicon material may first be deposited onto the substrate 105 and covered with a photoresist layer (not shown). The photoresist layer may be patterned using contact photolithography in which all the photoresist is exposed except for the rings of the zone plate. The structure may then be subjected to reactive ion etching that removes all the amorphous silicon, except where covered by the photoresist. The photoresist may then be removed, leaving the zone plate's rings. FIG. 3C depicts an embodiment in which the zone plate has been formed in the substrate 105. The rings 210 of the zone plate are defined topographically in the substrate. This embodiment may employ soft lithography, in which the substrate 105 comprises a soft polymer, e.g., polydimethylsiloxane (PDMS). The PDMS may be poured over a mold, e.g., the structure formed in FIG. 3A, cured, and subsequently peeled off to yield the embodiment of FIG. 3C. Other methods by which the zone plate 120, or arrays of zone plates, may be fabricated will be known to those skilled in the art of microfabrication.

For the embodiment depicted in FIG. 3A, the metal 310 may be selected to block most or all radiation incident on the metal. For the embodiments of FIG. 3B, the material 320 may be selected to attenuate and/or provide a desired phase shift to radiation incident on the material 320. The material 320 may be selected to have a high index of refraction, e.g., greater than a value of about 2.0. When the materials index of refraction is high, the thickness of the material is reduced for a desired phase shift. This can result in easier microfabrication steps, e.g., a shorter reactive ion etching step to etch the zone plate pattern. The desired phase shift may be one-half of a wavelength of the radiation which is detected by the detector, or π radians. In some embodiments, the desired phase shift may be between one-quarter and three-quarters of a wavelength, more particularly between π/2 and 3π/2 radians.

Referring again to FIG. 1A, a layer of material 110 may be disposed on the zone plate 120. The layer of material 110 may comprise a liquid-borne polymer which has been spin-coated onto the substrate 105 and subsequently baked or cured. The layer may comprise an inorganic material, e.g., SiOₓ, which has been deposited or grown by physical or vapor deposition. The layer of material 110 may comprise, in some embodiments, a film of material which is applied to the substrate 105 and adheres to the substrate, e.g., a thin film of polymeric material which adheres by surface interaction to the substrate. In various embodiments, the layer of material 110 transmits at least a portion of radiation passing through the zone plate. In some embodiments, the layer of material 110 may be adapted to exhibit optical filtering characteristics, e.g., blocking at least a portion of radiation incident upon the material 110.

The layer of material 110 can serve several functions. First, the layer of material can protect the zone plate from damage or picking up particles that, may interfere with the optical properties of the zone plate. Any particles that may be picked up by the zone-plate structure may be readily cleaned from the surface of the material 110 without risk of damaging the zone plate 120. The layer of material 110 may be thin in some embodiments (e.g., less than 1 micron, less than 500 nm, less than 200 nm, and yet less than 100 nm in certain implementations). The layer of material 110 may also function as a “solid immersion” material, i.e., a material with a higher index of refraction than air that effectively shortens the focal length of the zone plate and increases the zone plate's NA. Additionally, the layer of material 110 may provide a boundary proximal the zone plate's focal region that can assure that an object will be located at the effective focal distance from the zone plate. This can facilitate positioning of the object in the zone plate's focal region.

The object 103 to be inspected may be located approximately at the focal region 251 of the zone plate 120, as illustrated in FIG. 2D (object not shown in this drawing). The object 103 may comprise any object desired to be inspected with a microscope. The object 103 may be any type of microparticle, e.g., a small manufactured particle such as a bead or colloidal particle, or a biological specimen, e.g., a cell, a protein, a nucleic acid, a virus, a peptide, a small molecule, etc. The object may be fluorescent, or it may be fluorescently labeled. The object 103 may be a component of an assay, e.g., a component or an agglomerated particle used to detect the presence of an analyte, or it may be a component of an assay used to detect an effect of a pharmaceutical agent.

The relay optic 140 may comprise any optic that relays an image of the zone plate 120 onto the detector 150. The image may be in focus, or out of focus at the detector. As one example, the relay optic may comprise a single refractive optical lens positioned between the zone plate 120 and the detector 150. As a further example, the relay optic may comprise a pair of refractive optical lenses. The relay optic may comprise a unity magnification telescope. In some implementations, the relay optic 140 may comprise a diffractive optical element and/or a binary optical element, or a combination of either or both of these optical elements and one or more refractive lenses. The relay optic 140 may function essentially as a pinhole aperture for the imaging system, and may have a suitable size (e.g., a one-inch diameter, a one-half-inch diameter, a two-inch diameter, or any other suitable size) selected so that the relay optic operates essentially as a pinhole aperture. To operate as a pinhole aperture, the relay optic 140 excludes unwanted radiation, travelling from the object 103, from the detector 150.

In various embodiments, the relay 140 optic has a numerical aperture with a value less than the numerical aperture of the zone plate 120. The NA of the relay optic may have a value between about 0.01 and about 0.5, more particularly between 0.01 and 0.5. In some embodiments, at least one lens of the relay optic has an NA value between about 0.01 and about 0.5, more particularly between 0.01 and 0.5. In various implementations, the relay optic 140 accepts a portion of radiation that is emitted from the object 103 and collected by the zone plate 120. It will be appreciated that selecting a relay optic 140 with a small NA value will exclude radiation travelling from the zone plate 120 at angles with respect to the optical axis 101 that exceed the acceptance angle of the small NA relay optic 140.

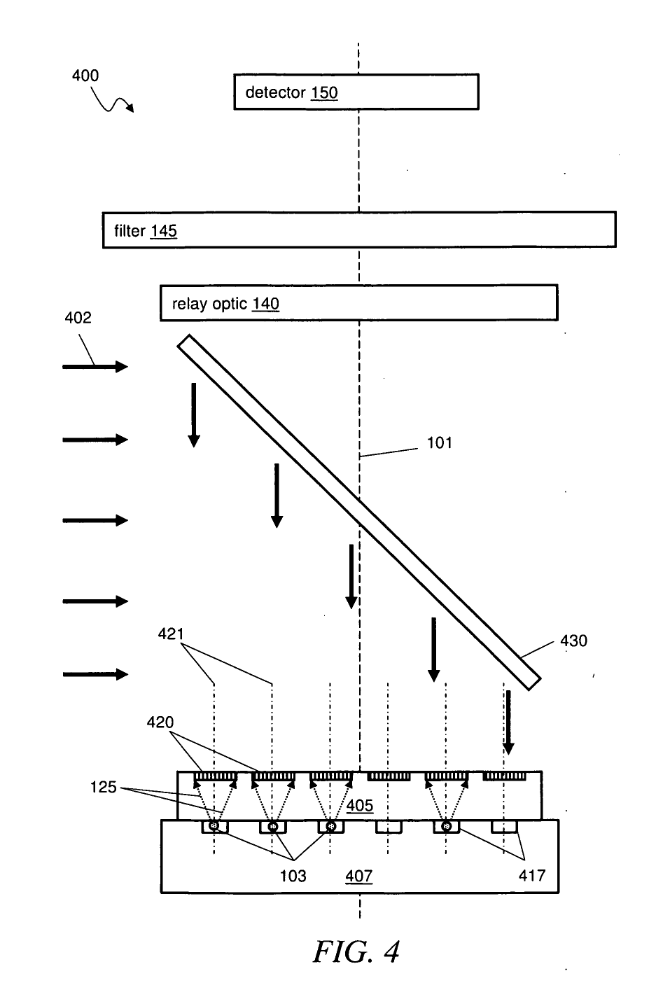

In various embodiments, the relay optic 140 is aligned substantially centrally with an optical axis of the zone plate 120. Referring to FIG. 1A, an optical axis (not shown) of the relay optic 140 and an optical axis (also not shown) of the zone plate 120 are aligned to be substantially collinear with the optical axis 101 shown for the apparatus 100. For embodiments in which a plurality of zone plates 120 are used, the optical axis of the relay optic 140 may be aligned centrally with the optical axes of the plurality of zone plates (i.e., to be aligned centrally, the optical axis of the relay optic may be aligned to be substantially parallel with and geographically centered among the optical axes of the plurality of zone plates). An example embodiment including a plurality of zone plates, with optical axes 421, and a centrally aligned relay optic is illustrated in FIG. 4.

An optical filter 145 may be disposed between the object 103 and the detector 150 and be any type and form of optical filter, e.g., an interference filter, an optical density filter, a polarizing beam splitter, a pellicle, etc. In some embodiments, more than one filter may be used. The optical filter 145 may be selected to block a portion of radiation directed toward the detector. For example, the filter may block radiation longer than a selected wavelength, shorter than a selected wavelength, or within a wavelength band. The blocked radiation may be radiation that would otherwise contribute to background signal or noise in the detector. As an example, the filter 145 may block ambient light. The filter 145 may be used in certain embodiments to block excitation radiation that is used to excite fluorescent radiation emitted from the object 103.

The filter 145 may be located at various positions in the apparatus 100. It may be located within the relay optic 140, before or after the relay optic, incorporated with the detector 150, or incorporated with the zone-plate structure, e.g., incorporated with the substrate 105 or material 110, in some embodiments. In some embodiments, the filter 145 may be incorporated in a lens or optical component of the relay optic 140. In certain implementations, the apparatus 100 may omit the filter, e.g., when illumination radiation scattered from the object 103 is being detected.

A detector 150 may be used with the sensing apparatus 100 to detect a level of radiation emitted from the object 103 and provided to the detector by the zone plate 120/relay optic 140 combination. The detector may be any type and form of detector that is responsive to radiation from the object 103, the radiation being desirable to detect. For example, the detector 150 may be responsive to fluorescent radiation emitted from the object 103. In some embodiments, the detector 150 may be responsive to illumination radiation emitted from the object 103, the illumination radiation scattered by the object. The detector may comprise a photodetector, an array of photodetectors, e.g., a CCD array. The detector 150 may comprise a photomultiplier, an avalanche photodiode, a CMOS photodetector, or an array of any of these types of detectors.

In one exemplary implementation, the sensing apparatus 100 may sense and record radiation emitted from an object 103 in the following way. Radiation emitted from the object 103 generally will radiate in all directions. The radiation emitted from the object may be fluorescent emission or may be illuminating radiation scattered by the object. In some implementations, it may be desirable to detect fluorescent emission, while in other implementations it may be desirable to detect scattered illuminating radiation. A portion of the emitted radiation will be collected by the zone plate 120 and directed generally towards the relay optic 140. Some of the radiation collected by the zone plate 120 will travel toward the relay optic at an angle with respect to the optical axis 101 that falls within an acceptance angle of the relay optic 140. The acceptance angle of the relay optic is determined by the NA of the relay optic. Radiation collected by the zone plate 120 and travelling toward the relay optic at an angle within the acceptance angle of the relay optic 140 will be relayed to and detected by the detector 150. All other radiation will be excluded from detection.

The inventors have recognized that by using a relay optic with a small NA value and a zone plate with a large NA value, off-axis and out-of-focus radiation emitted from the object 103 can be excluded from detection without using a confocal pinhole aperture in the apparatus 100. This aspect of operation is described in the co-pending application referred to above and entitled “Methods and Apparatus for Scanning Microscopy Using One or More Fresnel Zone Plates.” The inventors have recognized that the combination of NA values, for the zone plate 120 and for the relay optic 140, can be selected to limit detected radiation to be that which is emitted substantially from only within the focal region 251 of the zone plate 120. The apparatus 100 may then be used to detect radiation from a microscale region without the use of a pinhole aperture. The apparatus 100 may also be used for high-resolution imaging, by moving the object 103 with respect to the zone plate 120 and recording a sequence of detected light levels corresponding to each movement step of the object. High-resolution fluorescence imaging may be carried out in two dimensions, by moving the object 103 transverse to the optical axis 101 (i.e., in an X-Y plane), or alternatively in a direction along the optical axis (i.e., in a plane containing the Z axis), in a raster-scanning method. Three-dimensional imaging may also be obtained by systematically scanning the object in all three dimensions (e.g., recording a series of X-Y images at sequential Z positions).

The operation of the apparatus 100 may also be described as follows. By using a relay optic with a small NA value, the “field of view” of the zone plate/relay optic combination is restricted to a small area, e.g., in some embodiments, an area having a width on the order of the size of the focal region 251 of the zone plate. As used herein, “focal region” refers to a small volume at the effective focus of the zone plate that would be substantially filled by a diffraction limited focal spot. Expressed alternatively, the focal region refers to the spot focus that results when a uniform beam of monochromatic radiation impinges normally on the zone plate. The focal region may also be expressed as a surface which bounds a majority portion of the focused radiation (e.g., the full-width-half-maximum value of the focused radiation, the 1/e value of the focused radiation, the 1/e² value of the focused radiation).

Multiple different combinations of respective NA values for the relay optic 140 and the zone plate 120 are contemplated according to various embodiments of the present invention. For example, in some implementations, the inventors have found that the combination of NA values for the relay optic and the zone plate can be selected for some embodiments to yield a field of view for the apparatus 100 between about 200 nanometers and about 2 microns, more particularly between 200 nanometers and 2 microns. As a non-limiting example, if a zone plate has a diameter of about 50 microns and a NA_{zp} of 0.9, and the relay optic has an NAᵣₒ of 0.05, the field of view will be about 1 micron. In other implementations, the combination of NA values for the zone plate and relay optic may be selected to yield a field of view for the apparatus between about 100 nanometers and about 500 nanometers, more particularly between 100 nanometers and 500 nanometers. As a non-limiting example, if a zone plate has a diameter of about 40 microns and a NA_{zp} of 0.95, and the relay optic has an NAᵣₒ of 0.025, the field of view will be about 300 nanometers. Other combinations of NA values and zone plate design to yield different field of views FOV will be evident to those skilled in the art of optics from the following relation expressed in terms of zone plate focal length f and the numerical aperture of the relay optic NAᵣₒ:

FOV≈2f×NAᵣₒ. EQ. 3

or in terms of zone plate diameter d_{zp}, zone plate numerical aperture NA_{zp} and numerical aperture of the relay optic NAᵣₒ:

$$FOV \approx {d}_{zp} \sqrt{2 ( 1 - \frac{{NA}_{zp}}{n} )} \times {NA}_{ro} . \qquad EQ . 4$$

For the expressions of EQ. 3 and EQ. 4, it is assumed that the focal length of the zone plate is much less than the diameter of the zone plate. Not all implementations described herein will employ a zone plate for which its focal length is much less than its diameter. In such implementations, expressions other than those above may be used to determine a suitable zone plate/relay optic combination.

From EQ. 3 and EQ. 4 it will be appreciated that a zone plate and relay optic combination can be designed to provide a field of view that has a size substantially equal to the width of the microfluidic channel 117 (w_{c} in FIG. 1A). Additionally, the field of view may be designed to be larger than the zone plates's fluorescence focal region 251. In some implementations, the FOV may be greater than the width of the channel 117 by a factor between 1 and 4. In some implementations, the FOV may be less than the width of the microfluidic channel by a factor between 0.1 and 1. In some implementations, the FOV may be greater than the fluorescence focal region 251 by a factor between 1 and 4. In some implementations, the FOV may be less than the fluorescence focal region by a factor between 0.1 and 1. Since the FOV for any one zone plate can be limited to a small region in the vicinity of the microfluidic channel 117, any fluorescent emission from other objects at locations outside the FOV will not contribute significantly to the signal from a fluorescing object located within the FOV.

FIGS. 3D-3F depict various embodiments of integrated zone plate/microfluidic channel structures. The structures may be produced using any suitable microfabrication procedures. In various implementations, an integrated zone plate/microfluidic channel structure comprises a multilayer chip. The zone plate 120 or arrays of zone plates may be disposed on a first layer comprising a substrate 105. The first layer may be bonded to (e.g., using an adhesive or surface energy adhesion) a second layer comprising a substrate 107 having one or more microfluidic channels 117 formed thereon, as depicted in FIG. 3D. The bonding process may complete the formation of a microfluidic channel (e.g., a surface of the first substrate 105 forms an enclosing wall for the microfluidic channel. As illustrated in FIG. 3E, in some implementations, at least one microfabricated optical element and at least one microfluidic channel may be formed on and/or in the same substrate 105, which may be bonded to a second substrate 109. The substrates 105, 107 and 109 may each be glass or polymer substrates that transmit excitation radiation and/or fluorescent emission. FIG. 3F depicts one implementation in which an intermediate substrate 109 (e.g., a thin substrate of glass such as fused silica or quartz) is disposed between a first substrate 105, on which at least one zone plate is disposed, and a second substrate 107, having at least one microfluidic channel formed thereon. In exemplary implementations, the thickness of the intermediate substrate 109 in FIG. 3F may be approximately equal to, or equal to, the effective focal length of the zone plate for fluorescent emission of a microscale object to be inspected. In certain implementations, the intermediate substrate 109 may comprise the layer of material 110 as described elsewhere herein.

As used herein, the term “glass” may be used to refer to any type and form of an inorganic composition generally transmitting excitation radiation and fluorescence emission. Examples of glass include, but are not limited to, plate glass, quartz, fused silica, BK-7, sapphire, indium tin oxide, borosilicate glass, to name a few.

In exemplary implementations, the substrate 107, having at least one microfluidic channel formed thereon, is in releasable contact with the substrate 105, on/in which the zone plate is fabricated, or with the intermediate substrate 109. Releasable contact can be implemented when one of the substrates comprises a soft polymer (e.g., polydimethylsiloxane PDMS) and another substrate, to which it contacts, comprises any suitable material to which PDMS adheres (e.g., SiOₓ, fused silica, quartz, glass, silicon, sapphire.) Releasable contact is advantageous in that the substrate 107 having the microfluidic channels formed thereon may be removed, subjected to cleaning, and reused. The substrate 105 also may be cleaned and reused. As an example, referring to FIG. 3D, substrate 105 may comprise PDMS in which at least one zone plate has been formed via soft lithography, and substrate 107 may comprise glass (e.g., a fused silica substrate in which at least one microfluidic channel has been etched via reactive ion etching). As another example, referring to FIG. 3F, substrates 105 and 107 may comprise PDMS, and substrate 109 may comprise glass. In various embodiments, fluid loaded into the microfluidic channel 117 may convey at least one microscale particle in a microfluidic stream through the fluorescence focal region 251 of the zone plate.

To assemble the integrated structures as shown in FIGS. 3D-3F, substrate-to-substrate alignment may be required. Substrate-to-substrate alignment may be carried out in a manner similar to mask-to-substrate alignment in contact photolithography. Alignment marks may be place on substrate 105, on which one or more zone plates are disposed, and on substrate 107, having one or more microfluidic channels formed thereon. The alignment marks can then be viewed as the substrates are brought into close proximity. Positioning apparatus can then be used to align the first substrate 105 with respect to the second substrate 107. The substrates can then be brought into contact.

The inventors have recognized and appreciated that parallel confocal fluorescence microscopy may be performed using apparatus similar to that shown in FIG. 1A, but including an array of microfabricated optical elements, e.g., Fresnel zone plates 120. An exemplary apparatus according to one embodiment is depicted in FIG. 4. As can be seen in the drawing, only a single relay optic 140 is used in this example and operates as a confocal aperture for all the zone plates in the array. In some embodiments, each microfabricated optical element may be imaged by the relay optic onto a different part of an imaging detector 150. In some embodiments, the detector 150 may be an image sensor (e.g., a CMOS imaging CCD array). Thus, in some exemplary implementations, a single camera may be used to operate hundreds or thousands of zone-plate-based fluorescence confocal microscopes or sensors simultaneously. In various embodiments, the fields of view for the array of lenses are non-overlapping, so that fluorescent emission from an object 103 inspected by any one lens in the array does not contribute to a signal derived from fluorescent emission from any other object/lens combination in the array. As can be seen in the drawing and noted above, the relay optic 140 may be aligned centrally with the optical axes 421 of the plurality of microfabricated optical elements in the array.

There are several advantageous aspects of the present invention. Among these are advantages related to fluorescence sensing with micro-optofluidic chips utilizing a plurality of microfabricated optical lenses, as depicted in FIG. 4. In various implementations, a combination of NA values for the microfabricated optical lenses 420 and the relay optic 140 are selected such that the fields of view for the lenses/relay optic combination are non-overlapping. Such a combination of NA values can reduce unwanted signal from neighboring or adjacent lenses, and also permit operation of the micro-optofluidic structure without a pinhole aperture or without an array of pinhole apertures.

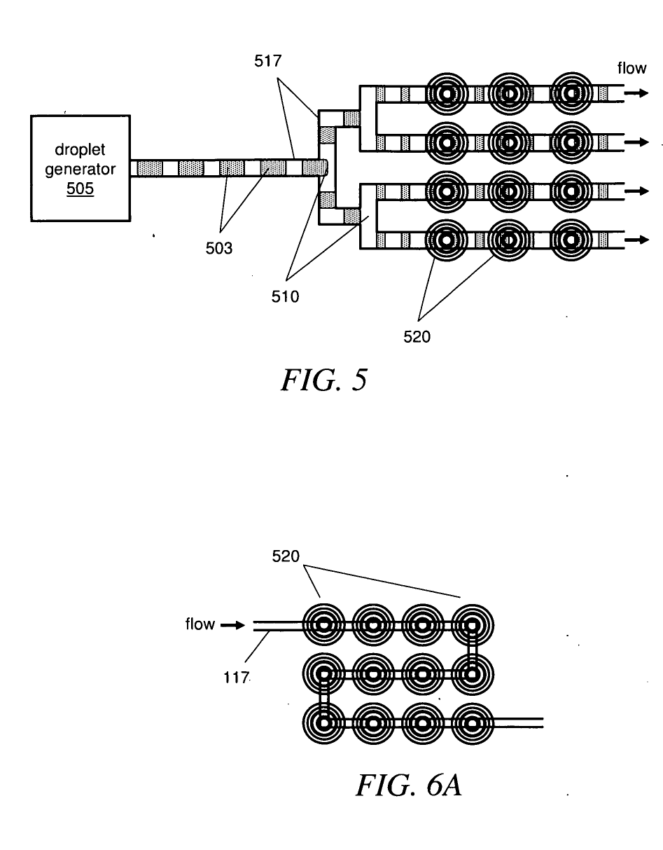

With reference now to FIG. 5, according to one embodiment of the present invention a droplet generator 505 and/or flow divider may be incorporated on the micro-optofluidic chip, as depicted in FIG. 5. The droplet generator 505 may comprise a small capillary or lumen or second microfluidic channel injecting a second fluid into a first fluid within a microfluidic channel. The injecting of the second fluid may form microscale drops 503 within the microfluidic channels 517. The drops 503 may form plug-like drops, as depicted in the drawing of FIG. 5, or may form generally spherically shaped drops dispersed within the first fluid. When the drops 503 are subjected to flow division (e.g., flow division at T junctions), the drops 503 may divide into a plurality of smaller drops as depicted in FIG. 5. The flow dividers 510 may be incorporated with the droplet generator 505 in some embodiments. In some implementations, the droplet generator 505 comprises flow dividers. As used herein, the term “droplet generator” may refer to droplet generator 505, the combination of a droplet generator 505 and at least one flow divider 510, or at least one flow divider.

In exemplary implementations, a droplet generator 505 provides a plurality of microscale drops 503 flowing in a plurality of microfluidic channels 517. The drops 503 may comprise a biochemical specimen and may contain at least one fluorescing component. The presence, signal level, and/or absence of a fluorescent emission from each drop may be indicative of a biochemical condition for specimen. In certain embodiments, the drops 503 may comprise microscale spheres within the fluid of the microfluidic channel.

As depicted in FIG. 5, an array of Fresnel zone plates 520 may be aligned to the array of microfluidic channels 517. Each zone plate in the array 520 may collect fluorescent emission from drops 503 as the drops are illuminated with excitation radiation and pass through each zone plate's focal region 251. It may be appreciated from the drawing of FIG. 5 that both parallel and temporal dynamic inspection may be carried out according to the exemplified embodiment. For example, zone plates farther down stream provide signals representative of later times. Although 16 zone plates and 4 microfluidic channels are shown in FIG. 5, embodiments of the present invention are not limited in this respect, as virtually any number of microfluidics channels and/or optical elements such as zone plates may be integrated onto a single chip.

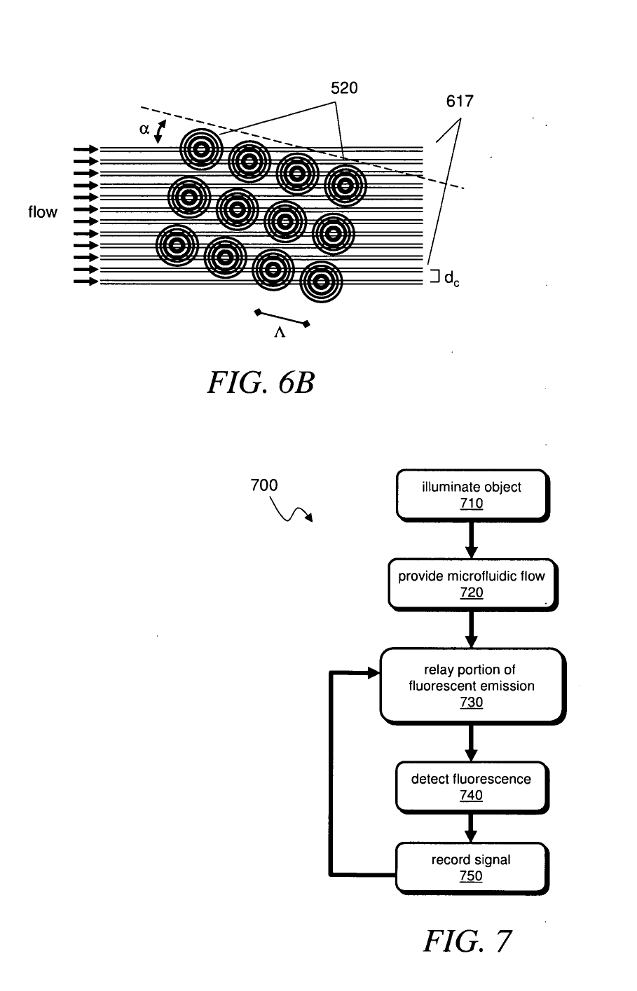

FIG. 6A depicts an embodiment of a micro-optofluidic chip adapted for temporal dynamic inspection of a microscale object. In this embodiment, a single serpentine channel 117 is aligned to a zone plate array 520. The layout of the channel 117 need not be rectilinear as depicted, and alternatively may comprise circular arcs at switchbacks. The zone plate array layout need not be square, and alternatively may comprise a triangular or hexagonal close-packed lattice. In some embodiments, the zone plate array may comprise a semi-regular lattice, or the zone plates may be disposed at irregular intervals along the microfluidic channel 117.

FIG. 6B depicts one exemplary embodiment of a micro-optofluidic chip in which each microfluidic channel in a channel array 617 is aligned with a focal region of each zone plate in a zone plate array. The channel spacing d_{c} can be less than the zone plate spacing Λ, as shown in the drawing. Alignment of zone plates to channels can be achieved by rotating the zone plate array with respect to the channels by the angle α. For the embodiment depicted in FIG. 6B, the zone plate array size will determine the channel-to-channel spacing. For a zone plate array of size M×N where N>M, the smallest regular channel-to-channel spacing will result when a is given by:

$$α = arctan ( \frac{1}{N} ) . \qquad EQ . 5$$

The channel spacing d_{c} will then be given by d_{c}=Λcos(α).

It may be appreciated that the device shown in FIG. 6B can also be used in a manner similar to the device of FIG. 6A to study dynamics in a very long length of microfluidic channel. Instead of an array of parallel channels as shown in FIG. 6B, a single serpentine channel could be used. The single serpentine channel may appear similar to the array, but with switchbacks at ends of the channels as appropriate.

Description of Methods

It should be appreciated that various inventive methods according to the concepts described herein may be carried out with some or all of the apparatuses described above. An exemplary method of zone-plate-based microscopy according to one embodiment of the present invention is depicted in the flow chart of FIG. 7.

In a particular implementation, a method 700 for optically inspecting an object may comprise illuminating 710 at least one object, providing 720 a flow of at least one object in at least one microfluidic channel, and relaying 730 to a location at least a portion of fluorescent emission emitted from the at least one object. The exemplary method 700 may further comprise detecting 740 the at least a portion of fluorescent emission with a detector, which may be located at the location to which the portion of fluorescent emission is relayed. The method 700 may further comprise recording 750 at least one signal level associated with the detected fluorescent emission. As may be appreciated, the steps of relaying 730, detecting 740, and recording 750 may be iterated to repetitively detect and record signals for a plurality of microscale objects provided in the flow of objects (e.g., a flow of droplets through a device similar to that depicted in FIG. 6B.

The step of illumination 710 may comprise illumination a microscale object in a microfluidic channel with any suitable wavelength and intensity of radiation. The radiation may be in the infrared wavelength band, visible wavelength band, ultraviolet or deep ultraviolet wavelength band. The illumination radiation may be coherent radiation, e.g., radiation from a laser, partially coherent, or incoherent radiation. The step of illuminating may comprising providing polarized or unpolarized illumination radiation. Polarized radiation may be polarized in any manner, e.g., linear, elliptical, or circular.

The step of illuminating 710 may comprise exciting fluorescence in the object, whether a property of the object itself or a fluorescing component added to the object or bound to the object. The fluorescent radiation emitted from the object may be the radiation desired to be detected by detector 150 in some embodiments. In other embodiments, the step of illuminating 710 may comprise scattering illumination radiation from the object 103, wherein the scattered radiation is detected by the detector 150. In some embodiments, the step of illuminating 710 may comprise both exciting fluorescence and scattering illumination radiation. Both fluorescent and scattered radiation from the object may be detected using time-division multiplexing or wavelength-division multiplexing detection methods.

The step of illuminating 710 may or may not comprise focusing the illumination radiation onto the object 103. A separate focusing optic may be used to focus illumination radiation onto the object 103 in some embodiments, e.g., a lens located near the object but opposite the zone plate. (See, for example, FIG. 1B.) In some implementations, the illuminating radiation is provided through the zone plate, which may focus the illuminating radiation onto the object 103. (See, for example, FIG. 1C.)

The act of providing a flow 720 of at least one object may comprise providing a flow of one or more microscale objects in at least one microfluidic channel. In some embodiments, a single channel may be used to provide a flow of objects to a plurality of microfabricated optical elements, whereas in other embodiments an array of channels may be used to provide a flow of objects to a plurality of microfabricated optical elements. In certain implementations, the objects generate fluorescence when illuminated by excitation radiation. When an object is excited by excitation radiation and at least a portion of the object is located within the field of view for a particular microfabricated optical element, at least a portion of the fluorescent emission emitted from the object passes through the particular microfabricated optical element.

In some implementations, providing a flow 720 comprises providing a flow of a plurality of microfluidic drops, which may be produced by a droplet generator 505. The microfluidic drops may be provided in one microfluidic channel or an array of microfluidic channels. The droplet generator may or may not comprise one or more flow dividers. The drops may be generated in at least one microfluidic stream, which conveys the drops to one or more microfabricated optical elements.

In some implementations, providing a flow 720 comprises providing a flow of a plurality of microscale objects in at least one microfluidic stream. The microscale objects may dispersed in a solution which is provided to one or more microfluidic channels. Flow dividers may or may not be used in combination with one microfluidic channel or an array of microfluidic channels. In various embodiments, the microscale objects may comprise biological or biochemical specimens, or microparticles such as colloidal particles, beads, or agglomerations. Exemplary size ranges of the microscale particles are between about 50 nanometers and about 200 microns, more particularly between 50 nanometers and 200 microns.

Flow may be provided in any suitable manner. In some implementations, flow is provided using pressure to force a fluid through the microfluidic channels. In some cases, vacuum may be applied to the microfluidic channels to draw a fluid through the channels. In some embodiments, electrophoretic flow may be employed. Electrodes may be disposed on the microfluidic chip and configured to provide electric fields along the microfluidic channels when activated by an electrostatic potential. The electric fields within the microfluidic channels can convey charged particles along the channels.

The relaying 730 may comprise directing a first portion of the portion of radiation collected by the microfabricated optical element (e.g., a Fresnel zone plate) to a location (e.g., a location at which the detector 150 is positioned), and excluding a second portion of the portion of radiation collected by the microfabricated optical element from the location. The directing and excluding may be carried out by a low-NA relay optic. The step of relaying 730 may comprise selecting a relay optic having an NA value so that the relay optic will provide a selected field of view for the microfabricated optical element/relay optic combination. The step of relaying 730 may further comprise positioning the relay optic, e.g., aligning the optical axis of the relay optic to the optical axis of the microfabricated optical element, or aligning the optical axis of the microfabricated optical element to the optical axis of the relay optic.

The step of detecting fluorescence 740 may comprise detecting an electrical signal level representative of the amount of fluorescence emitted by a fluorescing microscale object 103, collected at least in part by a particular microfabricated optical element 120, and relayed at least in part by a relay optic 140 to a detector 150. The detector may comprise a single photodetector, or an array of photodetectors (e.g., a CCD linear or imaging array) as described above. Signals from the detector may be provided to a signal recording and/or signal display apparatus. The display apparatus may comprise and video camera in some implementations and/or an oscilloscope. The step of detecting 740 may further comprise filtering the optical signal (e.g., filtering the fluorescent emission signal with a wavelength and/or polarization filter), and filtering the electrical signal (e.g., filtering the signal from the detector with a low-pass, high-pass, or band-pass filter).

In certain embodiments, diffractive properties of the microfabricated diffractive optical elements 120 may be used to spectrally resolve fluorescent emission at different wavelengths, e.g., emitted from different fluorophores. According to one embodiment, the apparatus 100 described herein may be used for multi-color fluorescence applications. In such applications, optical filtering utilizes the spectral resolution in the lens itself, and may obviate any need for a spectral filter bank. As an example and referring to FIG. 2D, the focal region 251 for a first fluorophor may be substantially within a microfluidic channel 117 whereas the focal region for a second fluorophor may be located outside the channel. The collection and excitation efficiency for the first fluorophor may be significantly greater than that for the second, so that the second fluorophor contributes negligibly to a signal collected by the zone plate. A second zone plate may be disposed at a second location along the microfluidic channel 117, upstream or downstream. The second zone plate may be designed to have a focal region for the second fluorophor that falls within the microfluidic channel, whereas the focal region for the first fluorophor is outside the channel.

The act of recording 750 may comprise recording a data signal representative of at least one light level from at least one microfabricated optical element detected by detector 150. The data signal may be recorded in computer-readable storage media. As an example, the detector 150 may be interfaced with a computer or processor (not shown in the figures) that repeatedly records data signals from the detector. The data signals may be plotted to show a time evolution of detected radiation from an object. When an object 103 moves with respect to a particular microfabricated optical element (e.g., moves along a microfluidic channel), the data signals may be recorded and plotted as a function of time to show evolution of the fluorescence. Accordingly, the step of recording may further comprise displaying at least one signal representative of the at least one light level detected by the detector 150.

It will be appreciated that when an array of microfabricated optical elements (e.g., zone plates 120) are used, the step of recording 750 may comprise recording a plurality of data signals representative of light levels from each of the zone plates in the array. In an embodiment employing an array of zone plates, a detector having an array of optical detectors may be used, e.g., a one- or two-dimensional CCD array, or an array of sensitive photodiodes or photomultipliers. In some embodiments, one pixel in the array of photodetectors may correspond to one zone plate in the array, e.g., receive radiation predominantly from the corresponding zone plate. In some embodiments, a group of pixels in the array of photodetectors may correspond to one zone plate in the array. A computer or processor may then record light data signals associated with each of the microfabricated optical elements and their corresponding microscale object 103 in the array. The step of recording 750 may further comprise recording separately, as well as displaying separately, data signals representative of light levels from each of a plurality of objects 103 and/or each of a plurality of optical elements in the array.

When parallel detecting 740 and recording 750 is carried out using computer processing methods, high-throughput fluorescence sensing can be achieved. For high-throughput sensing, the step of providing 720 a flow of objects may be carried out for an extended period of time, e.g., between about 10 seconds and about 10 hours, more particularly between 10 seconds and 10 hours. The steps of relaying 730, detecting 740, and recording 750, may be carried out in an automated or semi-automated process monitored or managed by a computer processor during the flow interval. Generally, the throughput rate Rₜ, or number of fluorescing objects that may be detected per second, will depend on several factors such as number of microfabricated optical elements in an array 520 that can be viewed simultaneously by an imaging detector 150, microfluidic flow rate, amount of fluorescent emission, on average, from the microscale objects, sensitivity of the detector 150, and noise levels. In one implementation, described below, the inventors have demonstrated that throughput rates R, on the order of 190,000 objects/second are obtainable with the inventive apparatus and methods described above.

### Example 1

### Multipoint Microfluidic Fluorescence Sensing

In this example, the effect of longitudinal dispersion on the transit times of fluorescent spheres through 12 detection regions along a serpentine microfluidic channel is investigated. This example illustrates how temporal dynamics over a long microfluidic channel length can be investigated.

For this example, a multilayer optofluidic device similar to the structure shown in FIG. 2D was fabricated and used. A thin No. 1 glass coverslip 109 is bonded to a polydimethylsiloxane (PDMS) microfluidic channel substrate 107. On the top side of the coverslip, a PDMS molded zone plate array on substrate 105 is first aligned to the microfluidic device and then reversibly adhered to the surface. Each microfabricated optical element of the zone plate array is designed to focus through the coverslip, which has a thickness of 165 μm in this exemplary embodiment. Zone plates exhibit chromatic aberration resulting in different focal lengths for the fluorescence excitation and emission, as described above. Each zone plate was also designed to have a focal length of the coverslip thickness for the longer wavelength fluorescence emission at 575 nm. The excitation radiation at 532 nm, however, is focused beyond the channel, resulting in a large excitation spot that slightly overfills the channel width. This is not detrimental, however, as the broad excitation beam that results is beneficial in order to uniformly excite the sample across the channel width.

Using a serpentine microfluidic channel similar to that illustrate in FIG. 6A, analyte can be directed towards the detection region of each zone plate in a square array. Accordingly, the sample can be detected as it flows through the micro-optofluidic chip at different times, permitting the measurement of dynamic processes. A 3×4 zone plate array was used, and the zone plates were spaced on a 241 μm pitch. Each zone plate has a 0.8 NA. The linear distance along the serpentine channel between the first detection region and the twelfth detection region is 2.6 mm. Compared to using a single 0.8 NA objective lens, which would typically have a field of view less than 200 μm, significantly larger dynamic range in both distance and time is possible in this optofluidic system.

In order to simultaneously collect a fluorescence signal from each detection region, the zone plate array was imaged onto a fast CMOS camera. A telescope was used as the relay optic. The zone plate array was illuminated with an excitation laser beam that has a width of 2 mm, which overfilled the array width of 1 mm. Video movies were recorded of the zone plate array at rates of 2k to 75k frames per second (fps) using a sub-region (16×32 pixels) of the camera. Each zone plate subtends approximately twenty pixels, which are integrated to obtain the signal from each detection region. Fluorescent beads were loaded 5 μm into the device at a 0.2% concentration by mass.

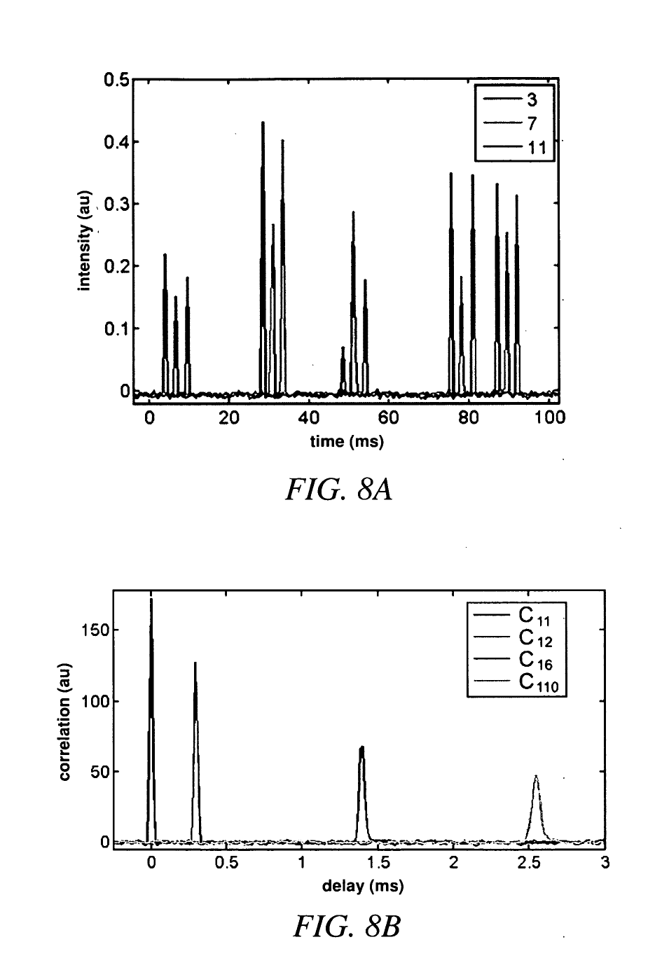

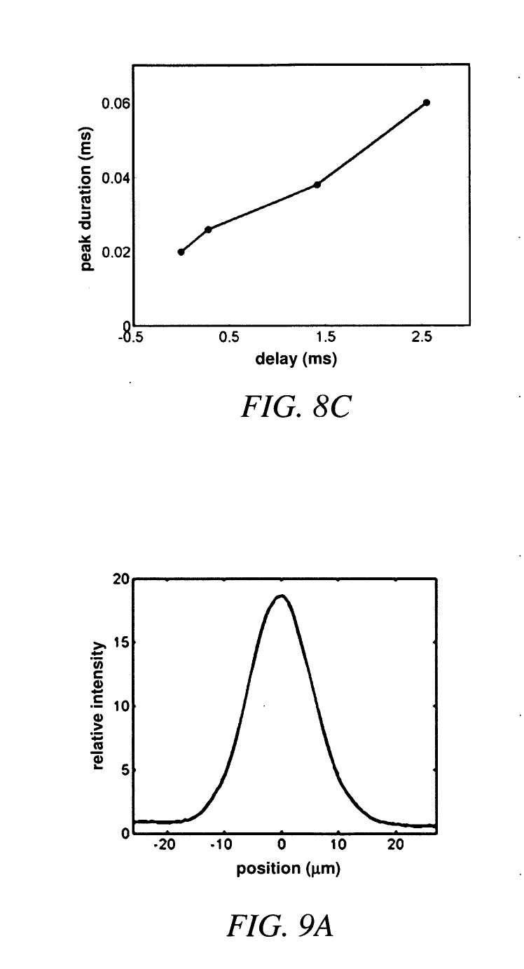

FIG. 8A shows a time trace of fluorescence signals from three of the zone plates in the array, that are each spaced 0.964 mm apart, for a volumetric flow rate of 300 μL/hour. The beads are reliably observed at each detection region, although the amplitude of the signal shows variation due to the illumination field not being completely uniform. The time delay between the detection regions is 0.275 ms, giving a velocity for this flow rate of about 0.35 m/s. It is found that the average bead velocity is the same between each detection region of the device.

In addition to measuring the average velocity of beads in the channel, the dispersion of velocities can be measured by analyzing the cross-correlation of the signals at different detection regions. The peak value of the cross-correlation signal gives the average time delay between the two measurements, and the width and shape of the peak give the distribution of bead velocities. Beads at different transverse locations in the channel travel at different velocities due to the parabolic velocity distribution in laminar flow. FIG. 8B shows the cross-correlation of the signals from the first detection region with the first (C₁₁), second (C₁₂), sixth (C₁₆), and the tenth (C₁₁₀) detection regions, respectively, for a flow rate of 1300 μL/hour. The peak values of the cross-correlation curves are consistent with an average bead velocity of 0.85 m/s along the channel. The width of the correlation peak also increases with the delay time, giving full width at half maximum values of 20, 26, 38, and 60 μs for C₁₁, C₁₂, C₁₆, C₁₁₀ respectively. For particles that have large convection velocities relative to diffusion rates, defined by the Peclet number, the velocity dispersion should increase linearly with time. (See T. M. Squires and S. R. Quake, “Microfluidics: Fluid physics at the nanoliter scale,” Rev. Mod. Phys. 77, 977 (2005).) The correlation peak widths, representative of velocity dispersion, are plotted in FIG. 8C as a function of time. Due to the large size of the beads and the fast flow velocity in this device, the Peclet number is large and there is reasonable agreement to this model.

### Example 2

### Design of a 64-Channel Device

In this example, the inventors demonstrate a zone-plate array optical detection system that is integrated into a massively parallel microfluidic device. The zone-plate array efficiently collects fluorescence signals at well defined regions spannihg a large area. Consequently, this multilayer micro-optofluidic platform enables parallelization not possible using a single conventional microscope objective lens.

The high throughput microfluidic device produces drops traveling through 64 parallel microfluidic channels. The drops are formed in a single flow-focus drop maker and then are subsequently split by six layers of drop splitters or flow dividers in a microfluidic device similar to that shown in FIG. 5. Each channel is 15 μm wide (w_{c}), 12 μm tall, and the channel spacing d_{c} is 30 μm. The drops are plug-like, conforming to the channel width and height, and are approximately 25 μm long. The drop volume is therefore ˜4 μL. This parallel sample delivery system produces a large 4 mm² region of quickly moving drops that require high-speed and sensitive optical detection for the measurements.

Although a microscope image of a substantial area of the device can be obtained with a conventional low magnification objective lens (10× magnification, 0.3 NA), the field of view would not be sufficient for imaging the entire device. It would be possible to use a conventional objective lens with an even lower magnification to increase the field of view, but such an objective lens would have an even smaller numerical aperture (NA) and consequently lower light collection efficiency.

Instead of using a single low NA objective, the optical detection system comprised an array of high NA zone plates, each confocally detecting from a localized region in a separate channel. Increasing the NA is significantly advantageous, because collection efficiency C scales approximately with the square of NA (C∂NA²). With the zone-plate array, fluorescence from a region in every microfluidic channel may measured simultaneously without scanning, in contrast to what is frequently done in other parallel detection systems. The lens array is illuminated by a laser providing excitation radiation, and is imaged onto a high speed CMOS camera using a unity magnification 0.13 NA telescope for the relay optic.

Since the zone plates are planar in contrast to lenses that use refraction across curved surfaces, they can readily be integrated into flat substrates in multilayer designs. Both the microfluidic device and the zone-plates are fabricated from PDMS using soft lithography. In addition to the advantages of being planar, zone plates are advantageous in lens arrays because their focal length can be defined with much higher accuracy and precision than refractive lens arrays. Zone plates can also provide significantly large NA values, and can be matched to the focusing medium, consequently minimizing effects of spherical aberration.

In various exemplary embodiments, each zone plate performs at least two functions. A first function is to produce a focused excitation spot for each microfluidic channel in the array. A second function is to collect the fluorescence emission over each detection region efficiently. For this example, the zone plates are designed to focus light through a 170 μm (t_{cover}) thick No. 1 coverslip 109 that is bonded to the top surface of the microfluidic substrate 107, as depicted in FIG. 2D. Zone plates exhibit chromatic aberration, and consequently the focal length for the excitation radiation with a wavelength of 532 nm is different from that for the fluorescence emission at a wavelength of 575 nm. The inventors have recognized that this aspect can be used advantageously for the micro-optofluidic chip, because the excitation radiation does not need to be focused into a diffraction limited spot within the microfluidic channel. Rather, the focused excitation radiation may approximately match the width of the microfluidic channel, w_{c}. Accordingly, the zone plates are designed to have a focal length of about 180 μm at a wavelength of 550 nm, which is in between the excitation and emission wavelengths. This difference in location of focal regions for the excitation radiation and fluorescence is illustrated in FIG. 2D. A numerical simulation of intensity distribution at the fluorescence excitation and emission wavelengths was also carried out, and confirms the dual-focus aspect for the micro-optofluidic structure. The excitation radiation is focused beyond the channel depth, and has a spatial width, at the location of the microfluidic channel, that substantially matches the channel width, even though the diffraction limited focal spot size is much smaller beyond the channel.

For the implementation of this example, as depicted in FIG. 2D, the zone plates operate as solid immersion lenses, because they focus through the glass coverslip 109. Solid immersion lenses have an NA that is enhanced by the refractive index of the background material, in this case glass. The diameter of each zone plate, d_{zp}, is 230 μm resulting in an enhanced NA of 0.81. Due to refraction at the glass-water interface, the collected cone angle in the detection region is larger than that possible in the absence of the coverslip but with the same zone plate diameter and focal length. In glass, each lens collects light over a half cone angle of 31°, corresponding to a half cone angle of 36° in water. Assuming that the fluorescence is emitted isotropically in water, the collection efficiency C_{ZP} of the zone plate is C_{ZP}=λ/2(1−cos θ_{cone})=2.7%, where λ is the diffraction efficiency of 29% of the zone plate, and θ_{cone} is the collection cone angle in water. By comparison, this collection efficiency is equivalent to that of a 0.48 NA objective lens with a transmission efficiency of 0.80.

In addition to a high collection efficiency, each zone plate provides for confocal filtering of the emitted fluorescence, meaning that the detection regions are well defined and do not overlap. Lower NA lens arrays have overlapping fields of view, which in applications like this example would produce cross-talk from neighboring channels. The detection region of each zone plate is confined because of vignetting in the relay optics. The condition for vignetting can be expressed as Δx=rᵣₒf_{ZP}/f_{relay}, where rᵣₒ is one-half the clear aperture diameter of the relay optic (selected to be 10 mm in this example), f_{relay} is the relay lens focal length (selected to be 100 mm in this example), and f_{ZP} is the zone plate focal length (selected to be 180 μm in this example). Vignetting starts to occur in this system at a transverse distance of about 9 μm from the optical axis of the zone plate. Thus, for this implementation the detection region has a width of about 18 μm, slightly larger than the width of the microfluidic channels.

### Example 3

### Characterization of Excitation and Collection

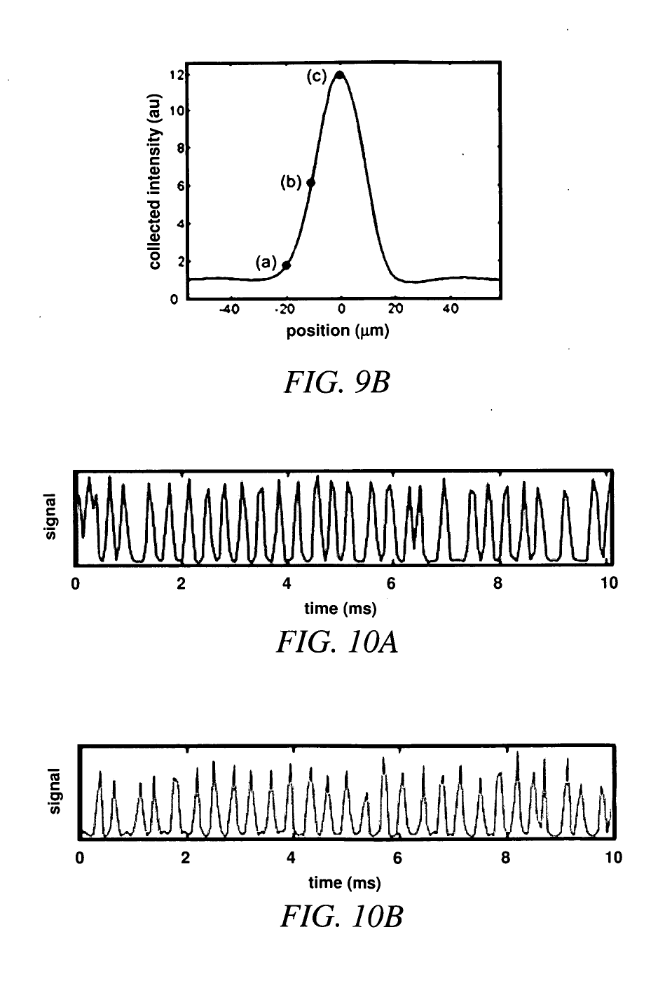

Excitation and collection characteristics for a micro-optofluidic device are measured in this example. For this study, the micro-optofluidic device of Example 2 above was used. By aligning a single zone plate to a dye filled microfluidic channel, separate measurements of enhancement due to increased excitation intensity and enhancement due to increased collection efficiency, relative to the low NA telescope, can be made. To characterize the excitation enhancement, the excitation laser is focused into the dye filled microfluidic channel using the zone plate. The emitted fluorescence is imaged onto a CCD camera using a microscope objective lens, and the image is recorded. The recorded image shows a bell-shaped distribution of detected fluorescence. FIG. 9A shows a one dimensional projection of the recorded image along the direction of flow. The background has been normalized to unity. The fluorescence, and consequently the excitation spot, has a full width at half maximum (FWHM) of about 16 μm, which slightly overfills the channel width of 15 μm. The peak value is 19 times higher than background, and demonstrates for this implementation that the zone plate enhances the excitation efficiency by about 19 times in comparison to the loosely focused incident beam.

The size and the relative enhancement of the collected fluorescent emission using the zone plate are characterized by scanning a tightly focused fluorescence excitation spot, generated by a microscope objective lens, and quantifying the fluorescence captured by a zone plate and imaged onto a CCD camera. Only fluorescence emitted from inside the zone plate's detection region is collimated and captured by the relay optics, otherwise it is filtered out by the confocal combination of zone plate and relay optic. FIG. 9B shows the integrated fluorescence over the aperture of the zone plate as a function of the excitation-spot position. The points marked (a)-(c) on the plot show signal levels when the excitation spot is 20, 10, and 0 μm from the zone plate center. The FWHM of the detection region of the zone plate imaging system is about 21 in reasonable agreement with that predicted by ray optics of about 18 p.m. FIG. 9B shows that the intensity of the fluorescence collected due to the zone plate is 12 times that collected by the relay optics alone. The enhancement of a factor of 12 agrees well with the theoretical collection based on the NA and diffraction efficiency of the zone plate. The combination of the excitation and collection enhancement gives a total fluorescence signal enhancement of a factor of 230 for an object located inside the detection region.

Since the detection region for a zone plate is smaller than the channel-to-channel spacing in this embodiment, fluorescent emission that could arise from neighboring microfluidic channels will not corrupt the signal from the zone plate. In addition for this implementation, the detection region is also slightly larger than the microfluidic drop size, so little of the fluorescence emission from each drop should be filtered out when the drop is centered under the zone plate.

### Example 4

### High Throughput Fluorescence Detection

In this example, high-throughput detection of fluorescence from microscale drops flowing in an array of microfluidic channels is demonstrated. An 8×8 zone-plate array patterned on a PDMS substrate is aligned to a 64-channel-array microfluidic device using a mask aligner and adhered to an opposite coverslip surface with a reversible bonding step. The multilayer, integrated micro-optofluidic chip appears similar to the structure of FIG. 2D, and the channel dimensions and zone-plate characteristics are those described in Example 2 above. The reversible bonding comprises bringing the PDMS substrate into releasable contact with the glass coverslip. In this implementation, a single PDMS lens array can be peeled off and reused with several microfluidic devices. By tilting the two-dimensional zone-plate array by an angle α (e.g., as illustrated in FIG. 6B) with respect to the microfluidic channel array, the optical axes of the zone plates can be substantially aligned to each channel, even though the zone plate pitch is much larger than the channel spacing. In this implementation, the zone-plate array is square and has 8 elements on a side for a total of 64 elements. The rotation angle α is then 7.13° according to EQ. 5. For the exemplified structure, the microfluidic channel spacing d_{c} and zone plate pitch Λ were selected to be 30 μm and 241 μm, respectively. Because Λ is significantly larger than d_{c}, each zone plate can be much larger than the channel width and consequently collect more excitation energy with which to focus into the channel.

To form microscale drops in the microfluidic channels, water containing 2 mM resorufin dye and hydrocarbon oil (HFE-7500) with a surfactant of carboxylic acid of Krytox 157 FSL at 1.8% by weight is loaded into the droplet generator 505 as the inner and outer fluid phases respectively. For the selected implementation of this example, the inner and outer flow rates of the drop maker are 8 and 20 μL/min, respectively. This results in drops being produced at approximately 200 Hz. When a drop containing the fluorophore passes through the detection region of a zone plate, the collected fluorescence peaks due to the excitation and collection enhancement. Images of the device in operation are taken with a CMOS camera operating at 1 k frames per second (fps).

At similar flow rates, the zone-plate array may also be imaged onto an electron-multiplying CCD (EMCCD), which has much greater sensitivity and lower pixel noise but a maximum frame rate of approximately 300 fps. Drops with resorufin concentrations as low as 1 μM have been imaged with signal to noise ratios of 20, but at rates approaching 100 drops per second per channel.

In order to obtain high-throughput detection, high frame rates achievable with high-speed CMOS cameras are utilized in an exemplary embodiment. The zone-plate array is illuminated with about 200 mW of excitation radiation and a beam diameter that substantially matches the diagonal length of the square zone-plate array, resulting in approximately 1.44 mW of excitation power incident on each zone plate in the array. The CMOS camera is operated in sub-array mode where each frame is 128×128 pixels and each pixel comprises a 22 μm square area. Because of the unity magnification telescope, the sub-array dimensions correspond to a 2.8 mm square field size, which is slightly larger than the 2 mm square zone-plate array. In this configuration, there are about 100 pixels of the imaging detector associated with each zone plate of the array.

From the captured image stack, the fluorescence signal corresponding to each detection region is found by integrating the ˜100 pixels associated with each zone plate. This is carried out for 62 of the 64 zone plates. The remaining two zone plates are misaligned, and do not produce appreciable signals. A Fourier transform of the time signals from active channels reveals that the drop rate in each channel is about 2975 Hz when the droplet generator is operated with inner and outer flow rates of 120 and 300 μL/min, respectively. When all 64 output channels are considered, this corresponds to an aggregate production and detection of about 190,000 drops per second.

FIGS. 10A-10B show example fluorescence signal traces of two representative microfluidic channels when a CMOS camera is operated to capture images at 16,000 fps. Assuming that the drops travel at the net volumetric flow rate, the average drop velocity is 615 mm/s. In the 62.5 μs in between captured frames of the image stack, drops travel 38 μm. The interframe travel distance and drop size, in combination with the excitation and collection volumes of each zone plate, may be used to set the spatial resolution in the flow direction.

### CONCLUSION

All literature and similar material cited in this application, including, but not limited to, patents, patent applications, articles, books, treatises, and web pages, regardless of the format of such literature and similar materials, are expressly incorporated by reference in their entirety. In the event that one or more of the incorporated literature and similar materials differs from or contradicts this application, including but not limited to defined terms, term usage, described techniques, or the like, this application controls.

The section headings used herein are for organizational purposes only and are not to be construed as limiting the subject matter described in any way.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

It should be appreciated that the various techniques described herein may be operated in different modes, and that the technology is not limited to being operated in any particular mode. For example, in one embodiment, an imaging system may be operated in epifluorescence mode (i.e., the entire sample is illuminated with fluorescence excitation). In some embodiments, the imaging system may be operated in a confocal mode. The differing modes may be chosen based on a particular application. For example, the confocal mode may provide higher resolution, and may allow for three dimensional inspection of a microscale object in addition to two dimensional sectioning.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments of the invention can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single computer or distributed among multiple computers.

In this respect, various aspects of the invention, e.g., signal acquisition from the detector 150, flow rate control, and droplet generation, may be embodied at least in part as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium or non-transitory medium) encoded with one or more programs that, when executed on one or more computers or other processors, perform methods that implement the various embodiments of the technology discussed above. The computer readable medium or media can be transportable, such that the program or programs stored thereon can be loaded onto one or more different computers or other processors to implement various aspects of the present technology as discussed above.

The terms “program” or “software” are used herein in a generic sense to refer to any type of computer code or set of computer-executable instructions that can be employed to program a computer or other processor to implement various aspects of the present technology as discussed above. Additionally, it should be appreciated that according to one aspect of this embodiment, one or more computer programs that when executed perform methods of the present technology need not reside on a single computer or processor, but may be distributed in a modular fashion amongst a number of different computers or processors to implement various aspects of the present technology.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently; “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed is:

1. An apparatus comprising:
at least one microfluidic channel;
at least one microfabricated optical element coupled to the at least one microfluidic channel and disposed with respect to the at least one microfluidic channel so that an optical axis of the at least one microfabricated optical element passes through the at least one microfluidic channel; and
a relay optic configured to operate as a confocal pinhole aperture and to relay at least a portion of radiation collected by the at least one microfabricated optical element to a detecting location.

2. The apparatus of claim 1 further comprising a droplet generator configured to provide a plurality of droplets dispersed within the at least one microfluidic channel, the at least one microfluidic channel configured to convey the plurality of droplets through at least one region of the at least one microfluidic channel, the at least one region having the optical axis of the at least one microfabricated optical element passing therethrough.

3. The apparatus of claim 1, wherein the at least one microfabricated optical element comprises at least one Fresnel zone plate.

4. The apparatus of claim 1, wherein the at least one microfabricated optical element is formed in polydimethylsiloxane or glass.

5. The apparatus of claim 1 further comprising:
a first substrate, the at least one microfabricated optical element being disposed on a first side of the first substrate; and
a second substrate, the at least one microfluidic channel being disposed on a first side of the second substrate.

6. The apparatus of claim 5, wherein the first substrate contacts the second substrate to form a multilayer chip.

7. The apparatus of claim 5 further comprising a layer of material, the layer of material disposed between the first substrate and the second substrate and having a thickness between about one-half and one-and-one-half a selected focal length of the at least one microfabricated optical element.

8. The apparatus of claim 1 further comprising:
a first substrate, the at least one microfabricated optical element being disposed on a first side of the first substrate and the at least one microfluidic channel being disposed on a second side of the first substrate.

9. The apparatus of claim 1, wherein the at least one microfabricated optical element comprises one microfabricated optical element of an array of microfabricated optical elements and/or the at least one microfluidic channel comprises one microfluidic channel of an array of microfluidic channels.

10. The apparatus of claim 9, wherein respective fields of view associated with at least two adjacent microfabricated optical elements in the array of microfabricated optical elements are non-overlapping.

11. The apparatus of claim 9, wherein optical axes of plural microfabricated optical elements of the array of microfabricated optical elements pass through the at least one microfluidic channel.

12. The apparatus of claim 9, wherein optical axes of plural microfabricated optical elements of the array of microfabricated optical elements pass through plural microfluidic channels of the array of microfluidic channels.

13. The apparatus of claim 9 further comprising a detector located at the location, wherein the detector is a two-dimensional imaging detector.

14. The apparatus of claim 9 further comprising an illumination source configured to illuminate the array of microfabricated optical elements.

15. The apparatus of claim 9, wherein the at least one microfabricated optical element is configured to collect radiation emitted from a detection region containing a portion of the at least one microfluidic channel, the detection region having a transverse extent between about one-half micron and about 100 microns.

16. A fluorescence sensing system comprising the apparatus of claim 1 or 9 further comprising:
an illumination source, the illumination source configured to irradiate at least one microfabricated optical lens with excitation radiation, the at least one microfabricated optical lens being configured to focus the excitation radiation onto at least one microfluidic channel; and
a detector configured to detect at least a portion of fluorescence from at least one object flowing through the at least one microfluidic channel.

17. A multilayer apparatus comprising:
a first layer comprising a first substrate;
at least one Fresnel zone plate formed on the first substrate;
a second layer comprising a second substrate; and
at least one microfluidic channel formed on the second substrate; wherein
the first and second layers are adapted to be placed in releasable contact with each other or a third layer to form a multilayer micro-optofluidic chip, and wherein, in the chip, the at least one Fresnel zone plate is configured to have a first focal region for excitation radiation, the first focal region substantially outside the at least one microfluidic channel, and a second focal region for fluorescent emission excited by the excitation radiation, the second focal region substantially within the at least one microfluidic channel.

18. The apparatus of claim 17 further comprising a droplet generator configured to provide a plurality of droplets dispersed within the at least one microfluidic channel, the at least one microfluidic channel configured to convey the plurality of droplets to the at least one Fresnel zone plate.

19. The apparatus of claim 18, wherein the droplet generator comprises a plurality of microfluidic T junctions disposed on the second substrate.

20. The apparatus of claim 17, wherein the first and/or second substrate comprises polydimethylsiloxane.

21. The apparatus of claim 17, wherein the at least one Fresnel zone plate comprises one Fresnel zone plate of an array of Fresnel zone plates disposed on the first substrate and/or the at least one microfluidic channel comprises one microfluidic channel of an array of microfluidic channels disposed on the second substrate.

22. The apparatus of claim 21, wherein second focal regions of plural Fresnel zone plates of the array of Fresnel zone plates are substantially within the at least one microfluidic channel.

23. The apparatus of claim 21, wherein second focal regions of plural Fresnel zone plates of the array of Fresnel zone plates are substantially within plural microfluidic channels of the array of microfluidic channels.

24. An apparatus, comprising:
an array of microfabricated optical elements; and
a microfluidic drop generator configured to generate microfluidic drops,
wherein the array of microfabricated optical elements and the microfluidic drop generator are integrated on a same chip.

25. The apparatus of claim 24, wherein the microfluidic drop generator and the array of microfabricated optical elements are fabricated of polydimethylsiloxane or glass.

26. The apparatus of claim 24, wherein the microfluidic drop generator is configured to provide the microfluidic drops on a first side of the array, and wherein the apparatus further comprises a relay optic disposed on a second side of the array and configured to receive light collected by the array.

27. The apparatus of claim 26, further comprising an excitation source, wherein the array focuses light received from the excitation source onto the microfluidic drops.

28. The apparatus of claim 27, wherein the excitation source comprises a laser.

29. The apparatus of claim 24, wherein the array of microfabricated optical elements comprises an array of Fresnel zone plates.

30. The apparatus of claim 24, wherein the drops are conveyed to plural microfabricated optical elements of the array of microfabricated optical elements in at least one microfluidic channel.

31. A fluorescence sensing method, comprising:
irradiating at least one microfabricated optical lens with excitation radiation, the at least one microfabricated optical lens being configured to focus the excitation radiation onto at least one microfluidic channel;
providing a flow of at least one object in the at least one microfluidic channel, the at least one object generating a fluorescent emission when irradiated by the excitation radiation, at least a portion of the fluorescent emission passing through the at least one microfabricated optical lens; and
relaying at least some of the portion of the fluorescent emission passing through the at least one microfabricated optical lens to a detecting location with a relay optic, the relay optic configured to exclude radiation emitted a selected distance from the at least one object generating the fluorescent emission.

32. The method of claim 31, wherein the at least one microfabricated optical lens comprises at least one microfabricated Fresnel zone plate.

33. The method of claim 32, wherein the at least one Fresnel zone plate comprises one Fresnel zone plate of an array of Fresnel zone plates, and wherein respective fields of view associated with at least two adjacent Fresnel zone plates in the array of Fresnel zone plates are non-overlapping.

34. The method of claim 32, wherein the at least one Fresnel zone plate is configured to have a first focal region for the excitation radiation, the first focal region substantially outside the at least one microfluidic channel, and a second focal region for the fluorescent emission excited by the excitation radiation, the second focal region substantially within the at least one microfluidic channel.

35. The method of claim 32, wherein the at least one object comprises one microfluidic droplet of a plurality of microfluidic droplets.

36. The method of claim 32, wherein the at least one object comprises one biochemical specimen of a plurality of biochemical specimens.

37. The method of claim 32, wherein the at least one object comprises one microscale object of a plurality of microscale objects.

38. The method of claim 32 further comprising detecting, with a detector located at the location, at least one signal level representative of the fluorescent emission from the at least one object.

39. The method of claim 38 further comprising recording the signal level.

40. The method of claim 38, wherein the detector comprises an imaging detector, the at least one Fresnel zone plate comprises an array of Fresnel zone plates, and wherein the detecting comprises detecting a plurality of signal levels simultaneously from the array of Fresnel zone plates.
